(19) United States
(12) Patent Application Publication
(10) Pub. No.: US 2024/0404740 A1
(43) Pub. Date: Dec. 5, 2024

(54) MULTILAYER ELECTRONIC COMPONENT

(71) Applicant: TDK Corporation, Tokyo (JP)

(72) Inventors: Yusuke Nagai, Tokyo (JP); Takahiro Sato, Tokyo (JP); Hidenobu Umeda, Tokyo (JP); Takeshi Shibayama, Tokyo (JP); Shinichi Sato, Tokyo (JP); Yuya Ishima, Tokyo (JP); Youhei Iida, Tokyo (JP); Mitsuharu Koike, Tokyo (JP); Keito Yasuda, Tokyo (JP); Takato Sasaki, Tokyo (JP)

(73) Assignee: TDK Corporation, Tokyo (JP)

(21) Appl. No.: 18/635,645

(22) Filed: Apr. 15, 2024

(30) Foreign Application Priority Data
May 31, 2023 (JP) 2023-090004

(51) Int. Cl. H01F 17/00; H01F 27/32

(52) U.S. Cl. CPC H01F 17/0013; H01F 27/324

(57) ABSTRACT

A multilayer coil component includes an element body that contains a plurality of metal magnetic particles made of a soft magnetic material, and at least two conductors that are in contact with the element body. Surfaces of the plurality of metal magnetic particles are covered by an oxide film having an insulating property, an insulating portion having an insulating property is formed in at least a part of a surface of at least one conductor of the two conductors in the conductor, and a thickness of the insulating portion is larger than a thickness of the oxide film.

### TECHNICAL FIELD

The present disclosure relates to a multilayer electronic component.

### BACKGROUND

For example, an electronic component described in Japanese Unexamined Patent Publication No. 2017-76700 is known as a multilayer electronic component. The multilayer electronic component described in Japanese Unexamined Patent Publication No. 2017-76700 includes a rectangular parallelepiped magnetic body portion made of a magnetic material, a coil disposed inside the magnetic body portion, and a pair of external electrodes provided in the magnetic body portion and electrically connected to the coil.

### SUMMARY

In the multilayer electronic component, for example, a short circuit may occur between coil conductors constituting the coil and between the coil conductor and the external electrode.

An object of one aspect of the present disclosure is to provide a multilayer electronic component capable of improving a withstand voltage between conductors.

(1) A multilayer electronic component according to an aspect of the present invention includes an element body that contains a plurality of metal magnetic particles made of a soft magnetic material, and at least two conductors that are in contact with the element body. Surfaces of the plurality of metal magnetic particles are covered by a first insulating portion having an insulating property, a second insulating portion having an insulating property are disposed in at least a part of a surface of at least one conductor of the two conductors in the conductor, and a thickness of the second insulating portion is larger than a thickness of the first insulating portion.

In the multilayer electronic component according to the aspect of the present invention, in at least one conductor of two conductors, the second insulating portions having the insulating properties are disposed on at least a part of the surface of the conductor. The thickness of the second insulating portion is larger than the thickness of the first insulating portion. As described above, in the multilayer electronic component, since the second insulating portion thicker than the first insulating portion is disposed between the conductors, the occurrence of the short circuit between the conductors can be suppressed.

Accordingly, in the multilayer electronic component, the withstand voltage between the conductors can be improved.

(2) In the multilayer electronic component of the above (1), the two conductors may be coil conductors. In this configuration, the short circuit between the coil conductors can be suppressed. Accordingly, in the multilayer electronic component, a withstand voltage between the coil conductors can be improved.

(3) The multilayer electronic component of the above (1) may include a terminal electrode that is disposed on the element body, one conductor of the two conductors may be a coil conductor, and the other conductor of the two conductors may be the terminal electrode. In this configuration, the short circuit between the coil conductor and the terminal electrode can be suppressed. Accordingly, in the multilayer electronic component, the withstand voltage between the coil conductor and the terminal electrode can be improved.

(4) In the multilayer electronic component according to any one of the above (1) to (3), a thickness of the second insulating portion may be 0.1 μm or more and 20.0 μm or less. In this configuration, the short circuit between the conductors can be more effectively suppressed.

(5) In the multilayer electronic component according to any one of the above (1) to (4), the element body may be formed by stacking a magnetic layer containing the metal magnetic particles, the two conductors may be disposed to face each other in a stacking direction of the magnetic layer, and the second insulating portion may be disposed between the two conductors. In this configuration, the short circuit between two conductors can be suppressed. Accordingly, in the multilayer electronic component, a withstand voltage between the coil conductors can be improved.

(6) In the multilayer electronic component of the above (5), the metal magnetic particles may include a normal particle having an ellipsoid shape, and a flat particle having an ellipsoid shape flatter in a thickness direction than the normal particle, and the normal particle and the flat particle may be disposed between the two conductors. Since the flat particle is disposed in a slight gap between the conductors, the number of metal magnetic particles present between the conductors can be increased as compared with a case where only the normal particle is used. Accordingly, the number of interfaces of the metal magnetic particles present between the conductors can be sufficiently secured, and the withstand voltage between the conductors can be improved. In a case where more flat particles are simply disposed in order to improve the withstand voltage, it is conceivable that a volume ratio of the metal magnetic particles between the conductors increases and a stray capacitance increases. By contrast, in the multilayer electronic component, the flat particle and the normal particle are mixed between the conductors. The normal particle thicker than the flat particle is disposed, and thus, an interval between the metal magnetic particles can be appropriately secured. Accordingly, an increase in stray capacitance can be suppressed.

(7) In the multilayer electronic component of the above (6), the flat particle may be disposed such that a surface including a major-axis direction and a minor-axis direction orthogonal to the thickness direction is along a formation surface of the conductor in the magnetic layer. In this configuration, the flat particle can increase the number of metal magnetic particles present between the conductors.

(8) In the multilayer electronic component according to any one of the above (1) to (7), the second insulating portion may be disposed across the two conductors. In this configuration, the metal particles are not disposed (not present) between two conductors. Thus, it is possible to reliably avoid the occurrence of the short circuit between two conductors via the metal particles.

(9) In the multilayer electronic component according to any one of the above (1) to (8), the element body may be formed by stacking a magnetic layer containing the metal magnetic particles, the two conductors may be coil conductors, and at least a part of the coil conductors may have conductor portions adjacent to each other as viewed from a stacking direction of a plurality of magnetic layers at the same height position in the stacking direction. In this configuration, in a configuration in which the conductor has a spiral shape, the withstand voltage between the conductors can be improved.

(10) In the multilayer electronic component of the above (9), the two conductors may be disposed to face each other in the stacking direction, the second insulating portion may include an inter-conductor portion disposed between the two conductors facing each other in the stacking direction and an inter-conductor-portion portion disposed between the two conductor portions adjacent to each other, and a thickness of the inter-conductor portion may be larger than a thickness of the inter-conductor-portion portion.

(11) In the multilayer electronic component of the above (9), the two conductors may be disposed to face each other in the stacking direction, the second insulating portion may include an inter-conductor portion disposed between the two conductors facing each other in the stacking direction and an inter-conductor-portion portion disposed between the two conductor portions adjacent to each other, and a thickness of the inter-conductor portion may be smaller than a thickness of the inter-conductor-portion portion.

(12) In the multilayer electronic component according to any one of the above (1) to (10), the conductor may be made of silver.

(13) In the multilayer electronic component according to any one of the above (1) to (11), the conductor may be a plated conductor. In this configuration, surface roughness of the conductor can be reduced. Thus, in the multilayer electronic component, continuity of the second insulating portion disposed on the surface of the conductor can be secured. In addition, in a case where heat treatment is performed in a manufacturing process of the multilayer electronic component, the plated conductor is less likely to thermally shrink or deform. Thus, occurrence of defects (failures) such as breakage in the second insulating portion disposed on the surface of the conductor can be suppressed.

According to the aspect of the present disclosure, the withstand voltage between conductors can be improved.

### BRIEF DESCRIPTION OF THE DRAWINGS

FIG. 1 is a perspective view of a multilayer coil component according to a first embodiment;

FIG. 2 is a diagram illustrating a sectional configuration of the multilayer coil component illustrated in FIG. 1;

FIG. 3 is a perspective view illustrating a configuration of a coil;

FIG. 4 is a schematic enlarged view illustrating a sectional configuration between coil conductors in an element body;

FIG. 5 is a diagram illustrating a sectional configuration of another form of the multilayer coil component illustrated in FIG. 1;

FIG. 6 is a diagram illustrating a sectional configuration of still another form of the multilayer coil component illustrated in FIG. 1;

FIG. 7 is a diagram illustrating a sectional configuration of still another form of the multilayer coil component illustrated in FIG. 1;

FIG. 8 is a diagram illustrating a sectional configuration of a multilayer coil component according to a second embodiment;

FIG. 9 is a perspective view illustrating a configuration of a coil of the multilayer coil component illustrated in FIG. 8;

FIG. 10 is a diagram illustrating a sectional configuration of another form of the multilayer coil component illustrated in FIG. 8;

FIG. 11 is a diagram illustrating a sectional configuration of still another form of the multilayer coil component illustrated in FIG. 8;

FIG. 12 is a diagram illustrating a sectional configuration of still another form of the multilayer coil component illustrated in FIG. 8;

FIG. 13 is a diagram illustrating a sectional configuration of still another form of the multilayer coil component illustrated in FIG. 8;

FIG. 14 is a diagram illustrating a sectional configuration of still another form of the multilayer coil component illustrated in FIG. 8;

FIG. 15 is a diagram illustrating a sectional configuration of a multilayer coil component according to a third embodiment;

FIG. 16 is a diagram illustrating a configuration of a coil of the multilayer coil component illustrated in FIG. 15;

FIG. 17 is a diagram illustrating a sectional configuration of another form of the multilayer coil component illustrated in FIG. 15;

FIG. 18 is a diagram illustrating a sectional configuration of still another form of the multilayer coil component illustrated in FIG. 15;

FIG. 19 is a diagram illustrating a sectional configuration of still another form of the multilayer coil component illustrated in FIG. 15;

FIG. 20 is a diagram illustrating a sectional configuration of still another form of the multilayer coil component illustrated in FIG. 15;

FIG. 21 is a diagram illustrating a sectional configuration of still another form of the multilayer coil component illustrated in FIG. 15;

FIG. 22 is a diagram illustrating a sectional configuration of a multilayer coil component according to a fourth embodiment; and

FIG. 23 is a diagram illustrating a sectional configuration of the multilayer coil component illustrated in FIG. 22.

### DETAILED DESCRIPTION

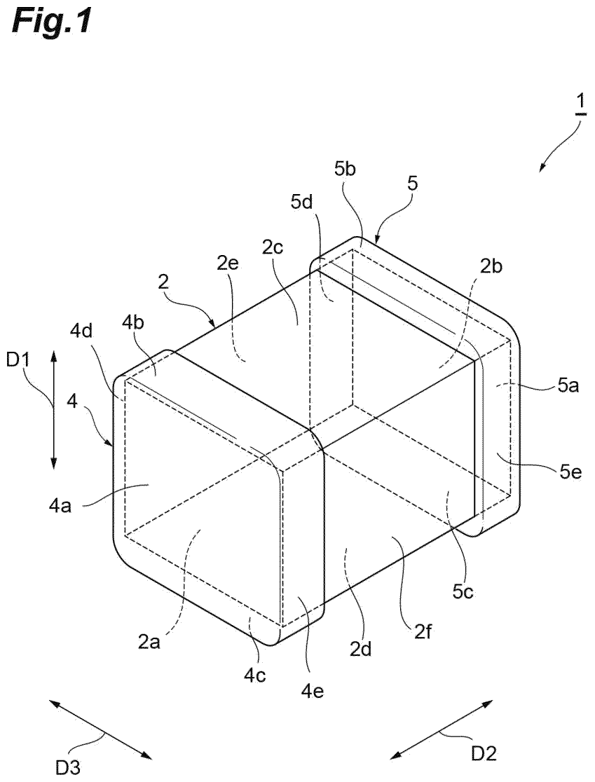

Hereinafter, preferred embodiments of the present invention will be described in detail with reference to the accompanying drawings. Note that, the same or corresponding elements in the description of the drawings are denoted by the same reference signs, and redundant description is omitted.

[First Embodiment] As illustrated in FIG. 1, a multilayer coil component (multilayer electronic component) 1 includes an element body 2, and a terminal electrode (conductor) 4 and a terminal electrode (conductor) 5 disposed at both end portions of the element body 2, respectively.

The element body 2 has a rectangular parallelepiped shape. The rectangular parallelepiped shape includes a rectangular parallelepiped shape in which corner portions and ridge line portions are chamfered, and a rectangular parallelepiped shape in which corner portions and ridge line portions are rounded. The element body 2 has, as outer surfaces thereof, a pair of end surfaces 2a and 2b facing each other, a pair of principal surfaces 2c and 2d facing each other, and a pair of side surfaces 2e and 2f facing each other. A facing direction in which the pair of principal surfaces 2c and 2d faces each other is a first direction D1. A facing direction in which the pair of end surfaces 2a and 2b faces each other is a second direction D2. A facing direction in which the pair of side surfaces 2e and 2f faces each other is a third direction D3. In the present embodiment, the first direction D1 is a height direction of the element body 2. The second direction D2 is a longitudinal direction of the element body 2, and is orthogonal to the first direction D1. The third direction D3 is a width direction of the element body 2, and is orthogonal to the first direction D1 and the second direction D2.

The pair of end surfaces 2a and 2b extends in the first direction D1 to connect the pair of principal surfaces 2c and 2d. The pair of end surfaces 2a and 2b also extends in the third direction D3 (short side direction of the pair of principal surfaces 2c and 2d). The pair of side surfaces 2e and 2f extends in the first direction D1 to connect the pair of principal surfaces 2c and 2d. The pair of side surfaces 2e and 2f also extends in the second direction D2 (long side direction of the pair of end surfaces 2a and 2b). When the multilayer coil component 1 is implemented on another electronic device (for example, a circuit board, a multilayer electronic component, or the like), the principal surface 2d can be defined as an implementation surface facing the other electronic device.

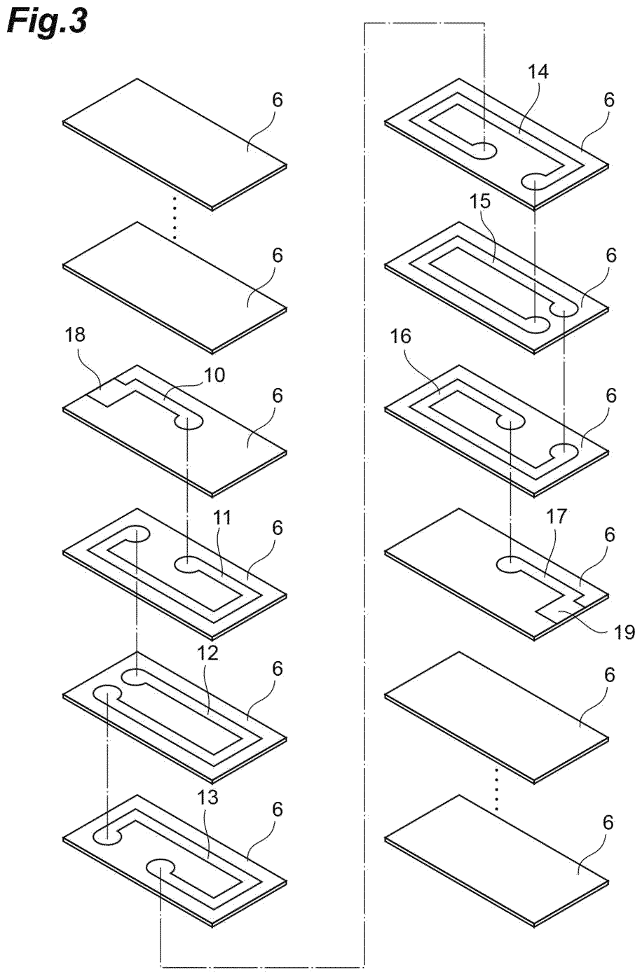

As illustrated in FIG. 3, the element body 2 is formed by stacking a plurality of magnetic layers 6. The magnetic layers 6 are stacked in the first direction D1. That is, the first direction D1 is a stacking direction. The element body 2 has the plurality of stacked magnetic layers 6. In the actual element body 2, the plurality of magnetic layers 6 are integrated to such an extent that boundaries between the layers cannot be visually recognized.

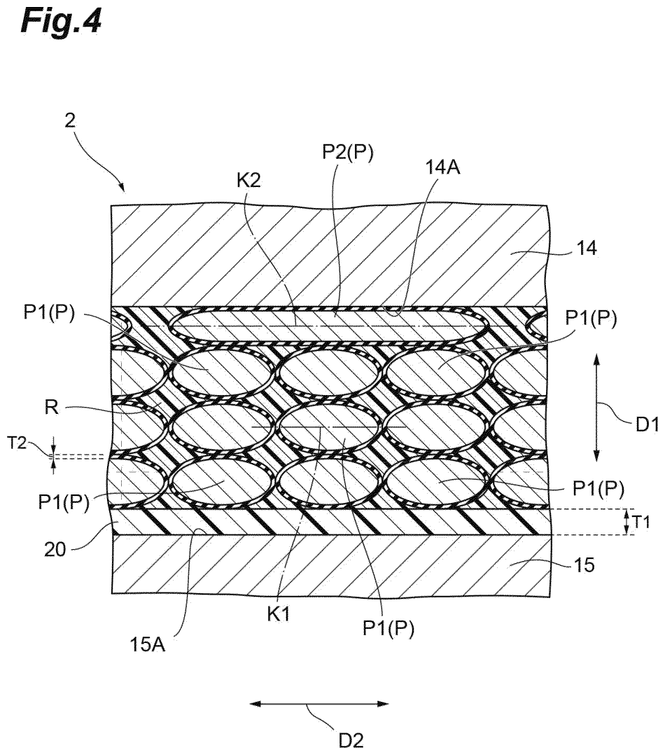

The element body 2 (magnetic layers 6) includes a plurality of metal magnetic particles P (see FIG. 4). The metal magnetic particles P are made of a soft magnetic alloy (soft magnetic material). The soft magnetic alloy is, for example, a Fe—Si-based alloy. When the soft magnetic alloy is a Fe—Si-based alloy, the soft magnetic alloy may contain P. The soft magnetic alloy may be, for example, a Fe—Ni—Si-M-based alloy. “M” contains one or more elements selected from Co, Cr, Mn, P, Ti, Zr, Hf, Nb, Ta, Mo, Mg, Ca, Sr, Ba, Zn, B, Al, and rare earth elements.

In the element body 2, the metal magnetic particles P and P are bonded to each other. The bonding between the metal magnetic particles P and P is realized by, for example, bonding between oxide films (first insulating portions) M formed on surfaces of the metal magnetic particles P. A thickness of the oxide film M is, for example, 5 nm or more and 60 nm or less. The oxide film M may include one or a plurality of layers.

As illustrated in FIG. 4, the element body 2 includes a portion filled with a resin R. The resin R is present in at least a part between the plurality of metal magnetic particles P and P. The resin R is a resin having an electrical insulation property. For example, a silicone resin, a phenol resin, an acrylic resin, an epoxy resin, or the like is used as the resin R. A void portion not filled with the resin R may be present between the plurality of metal magnetic particles P and P.

More specifically, the metal magnetic particles P include normal particles P1 having an ellipsoid shape and a flat particle P2 having an ellipsoid shape (disk shape) that is flatter in a thickness direction than the normal particles. The thickness direction is a direction defined for the sake of convenience. Here, in the state of being disposed in the element body 2, a stacking direction of the magnetic layers 6 is defined as the thickness direction of the normal particles P1 and the flat particle P2. The normal particle P1 has a surface (hereinafter, referred to as a reference surface K1) including a major-axis direction and a minor-axis direction orthogonal to the thickness direction. Similarly, the flat particle P2 has a surface (hereinafter, referred to as a reference surface K2) including a major-axis direction and a minor-axis direction orthogonal to the thickness direction. Here, a particle in which a length in the major-axis direction orthogonal to the thickness direction is three times or less a length in the thickness direction is defined as the normal particle P1, and a particle in which a length in the major-axis direction orthogonal to the thickness direction exceeds three times a length in the thickness direction is defined as the flat particle P2.

The normal particle P1 and the flat particle P2 have a long diameter and a short diameter, respectively, as viewed from a direction orthogonal to the thickness direction and as viewed from the thickness direction. In a relationship between the normal particle P1 and the flat particle P2, the long diameter of the normal particle P1 is smaller than the long diameter of the flat particle P2, and the short diameter of the normal particle P1 is larger than the short diameter of the flat particle P2. A volume of the normal particles P1 is larger than a volume of the flat particle P2. The volume of the normal particles P1 may be larger than twice the volume of the flat particle P2.

For example, a scanning electron microscope (SEM) can be used for measuring the short diameter and long diameter of the normal particle P1 and the flat particle P2 and measuring the volumes. In this case, a sectional photograph of the element body 2 is acquired by SEM, and the particle diameter and short diameter are measured by approximating a particle section to an ellipse. The volume is calculated based on an average value of particle diameters of the normal particle P1 and the flat particle P2 present in each section orthogonal to the first direction D1, the second direction D2, and the third direction D3 in a predetermined region of the element body 2.

As illustrated in an example of FIG. 4, a plurality of normal particles P1 and at least one flat particle P2 are disposed between a coil conductor 14 and a coil conductor 15. FIG. 4 schematically illustrates the disposition of the normal particles P1 and the flat particle P2. In the example of the drawing, three normal particles P1 and one flat particle P2 are arranged in the stacking direction (first direction D1) of the magnetic layers 6. The flat particle P2 comes into contact with one of the coil conductors 14 and 15. Three normal particles P1 are connected in a line in the stacking direction of the magnetic layers 6 and come into contact with the flat particle P2 and the other of the coil conductors 14 and 15.

In the example illustrated in FIG. 4, both the normal particles P1 and the flat particle P2 are disposed such that the thickness direction is along the stacking direction of the magnetic layers 6. In the normal particle P1, the long diameter is along one axis (here, the second direction D2) in an in-plane direction of the magnetic layer 6, and the short diameter is along the first direction D1 and the third direction D3. In the flat particle P2, the long diameter is along one axis (here, the second direction D2) in the in-plane direction of the magnetic layer 6, and the short diameter is along the first direction D1 and the third direction D3.

The flat particle P2 is disposed such that the reference surface K2 including the major-axis direction and the minor-axis direction orthogonal to the thickness direction is along a formation surface 14A of the coil conductor 14 in the magnetic layer 6. The formation surface 14A of the coil conductor 14 is a surface on which the coil conductor 14 is formed in the magnetic layer 6, and is a surface in which the second direction D2 and the third direction D3 are in-plane directions. The reference surface K2 of the flat particle P2 is parallel or substantially parallel to the formation surface 14A of the coil conductor 14.

The flat particle P2 is disposed so as to straddle the plurality of normal particles P1 in the major-axis direction. In the present embodiment, the long diameter of the flat particle P2 is larger than the long diameter of the normal particle P1, and the flat particle P2 is disposed across three normal particles P1 adjacent to each other in the second direction D2. In addition, in the present embodiment, the short diameter of the flat particle P2 is larger than the short diameter of the normal particle P1, and the flat particle P2 is disposed so as to straddle the plurality of normal particles P1 even in the third direction D3.

For example, a total volume of the normal particles P1 present between the coil conductors 14 and 15 is larger than a total volume of the flat particle P2 present between the coil conductors 14 and 15. The total volume of the normal particles P1 present between the coil conductors 14 and 15 may be larger than twice the total volume of the flat particle P2. The same applies to the other coil conductors. The total volume of the normal particles P1 and the total volume of the flat particle P2 can be calculated, for example, by magnifying the section of the element body 2 by 3000 times with a scanning electron microscope (SEM) and multiplying the volume of the normal particles P1 and the volume of the flat particle P2 by the numbers of normal particles P1 and the number of flat particles P2 in the section, respectively.

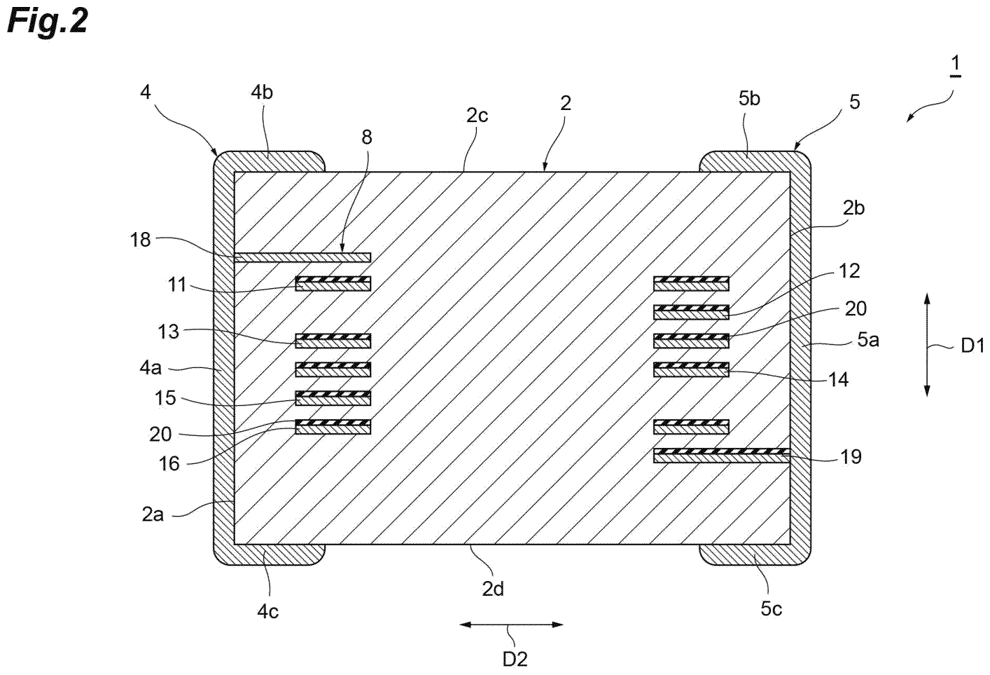

As illustrated in FIGS. 1 and 2, the terminal electrode 4 is disposed on the end surface 2a side of the element body 2, and the terminal electrode 5 is disposed on the end surface 2b side of the element body 2. That is, the terminal electrode 4 and the terminal electrode 5 are positioned apart from each other in the facing direction of the pair of end surfaces 2a and 2b. The terminal electrode 4 and the terminal electrode 5 include a conductive material (for example, Ag or Pd). The terminal electrode 4 and the terminal electrode 5 are formed as a sintered body of a conductive paste containing a conductive metal powder (for example, Ag powder or Pd powder) and glass frit. Electroplating is applied to the terminal electrode 4 and the terminal electrode 5 to form a plating layer on surfaces thereof. For example, Ni, Sn, or the like is used for electroplating.

The terminal electrode 4 is disposed on the one end surface 2a side. The terminal electrode 4 includes five electrode portions including a first electrode portion 4a positioned on the end surface 2a, a second electrode portion 4b positioned on the principal surface 2c, a third electrode portion 4c positioned on the principal surface 2d, a fourth electrode portion 4d positioned on the side surface 2e, and a fifth electrode portion 4e positioned on the side surface 2f. The first electrode portion 4a, the second electrode portion 4b, the third electrode portion 4c, the fourth electrode portion 4d, and the fifth electrode portion 4e are connected at a ridge line portion of the element body 2, and are electrically connected to each other. The terminal electrode 4 is formed on five surfaces of one end surface 2a, the pair of principal surfaces 2c and 2d, and the pair of side surfaces 2e and 2f. The first electrode portion 4a, the second electrode portion 4b, the third electrode portion 4c, the fourth electrode portion 4d, and the fifth electrode portion 4e are integrally formed.

In the present embodiment, edges (end surfaces) of the second electrode portion 4b and the third electrode portion 4c of the terminal electrode 4 are, for example, along the third direction D3. An edge of the second electrode portion 4b is linearly formed on the principal surface 2c. The edge of the third electrode portion 4c is linearly formed on the principal surface 2d. Edges of the fourth electrode portion 4d and the fifth electrode portion 4e of the terminal electrode 4 are along the first direction D1. The edge of the fourth electrode portion 4d is linearly formed on the side surface 2e. The edge of the fifth electrode portion 4e is linearly formed on the side surface 2f. Note that, the edges of the second electrode portion 4b, the third electrode portion 4c, the fourth electrode portion 4d, and the fifth electrode portion 4e may be curved or uneven.

The terminal electrode 5 is disposed on the other end surface 2b side. The terminal electrode 5 includes five electrode portions including a first electrode portion 5a positioned on the end surface 2b, a second electrode portion 5b positioned on the principal surface 2c, a third electrode portion 5c positioned on the principal surface 2d, a fourth electrode portion 5d positioned on the side surface 2e, and a fifth electrode portion 5e positioned on the side surface 2f. The first electrode portion 5a, the second electrode portion 5b, the third electrode portion 5c, the fourth electrode portion 5d, and the fifth electrode portion 5e are connected at the ridge line portion of the element body 2, and are electrically connected to each other. The terminal electrode 5 is formed on five surfaces of one end surface 2b, the pair of principal surfaces 2c and 2d, and the pair of side surfaces 2e and 2f. The first electrode portion 5a, the second electrode portion 5b, the third electrode portion 5c, the fourth electrode portion 5d, and the fifth electrode portion 5e are integrally formed.

In the present embodiment, edges of the second electrode portion 5b and the third electrode portion 5c of the terminal electrode 5 are, for example, along the third direction D3. The edge of the second electrode portion 5b is linearly formed on the principal surface 2c. The edge of the third electrode portion 5c is linearly formed on the principal surface 2d. Edges of the fourth electrode portion 5d and the fifth electrode portion 5e of the terminal electrode 5 are along the first direction D1. The edge of the fourth electrode portion 5d is linearly formed on the side surface 2e. The edge of the fifth electrode portion 5e is linearly formed on the side surface 2f. Note that, the edges of the second electrode portion 5b, the third electrode portion 5c, the fourth electrode portion 5d, and the fifth electrode portion 5e may be curved or uneven.

As illustrated in FIG. 2, in the multilayer coil component 1, a coil 8 is disposed in the element body 2. As illustrated in FIG. 3, the coil 8 is formed in a spiral shape by electrically connecting a plurality of coil conductors 10, 11, 12, 13, 14, 15, 16, and 17 to a first connection conductor 18 and a second connection conductor 19. The coil conductor 10 and the first connection conductor 18 are integrally formed. The coil conductor 17 and the second connection conductor 19 are integrally formed. Adjacent coil conductors 10, 11, 12, 13, 14, 15, 16, and 17 are electrically connected by through-hole conductors (not illustrated). The first connection conductor 18 constitutes one end portion of the coil 8. The first connection conductor 18 is exposed on the end surface 2a of the element body 2 and is connected to the terminal electrode 4 (first electrode portion 4a). The second connection conductor 19 constitutes the other end portion of the coil 8. The second connection conductor 19 is exposed on the end surface 2b of the element body 2 and is connected to the terminal electrode 5 (first electrode portion 5a).

The coil conductors 10, 11, 12, 13, 14, 15, 16, and 17, the first connection conductor 18, and the second connection conductor 19 are made of a conductive material usually used as a conductor of a coil. For example, Ag, Cu, Au, Al, Pd, a Pd/Ag alloy, or the like can be used as the conductive material. In the present embodiment, the conductive material is Ag. The coil conductors 10, 11, 12, 13, 14, 15, 16, and 17, the first connection conductor 18, and the second connection conductor 19 are formed as a sintered body of a conductive paste containing the conductive material.

As illustrated in FIG. 2, in the multilayer coil component 1, an insulating portion (second insulating portion) 20 is formed on surfaces of the coil conductors 11, 12, 13, 14, 15, 16, and 17 and the second connection conductor 19. The insulating portions 20 are formed by forming Cu plating on the surfaces of the coil conductors 11, 12, 13, 14, 15, 16, and 17 and the second connection conductor 19 by an electroless plating method and blackening the Cu plating.

The insulating portions 20 are disposed on the surfaces (upper surfaces) of the coil conductors 11, 12, 13, 14, 15, 16, and 17 and the second connection conductor 19 on the principal surface 2c side. In the example illustrated in FIG. 4, the insulating portion 20 is disposed on a surface 15A of the coil conductor 15. As illustrated in FIG. 2, the insulating portion 20 is disposed between the coil conductor 11 and the first connection conductor 18. The insulating portion 20 is disposed between the coil conductor 11 and the coil conductor 12. The insulating portion 20 is disposed between the coil conductor 12 and the coil conductor 13. The insulating portion 20 is disposed between the coil conductor 14 and the coil conductor 15. The insulating portion 20 is disposed between the coil conductor 15 and the coil conductor 16. The insulating portion 20 is disposed between the coil conductor 17 and the coil conductor 16.

The insulating portions 20 are not formed in portions where through-hole conductors are formed in the coil conductors 11, 12, 13, 14, 15, 16, and 17. The insulating portion 20 may be formed in the entire coil conductor 11, or may be formed only in a portion facing the first connection conductor 18 in the first direction D1. The insulating portion 20 may be formed in the entire coil conductor 12, or may be formed only in a portion facing the coil conductor 11 in the first direction D1. The insulating portion 20 may be formed in the entire coil conductor 13, or may be formed only in a portion facing the coil conductor 12 in the first direction D1. The insulating portion 20 may be formed in the entire coil conductor 14, or may be formed only in a portion facing the coil conductor 13 in the first direction D1.

The insulating portion 20 may be formed in the entire coil conductor 15, or may be formed only in a portion facing the coil conductor 14 in the first direction D1. The insulating portion 20 may be formed in the entire coil conductor 16, or may be formed only in a portion facing the coil conductor 15 in the first direction D1. The insulating portion 20 may be formed in the entire coil conductor 17, or may be formed only in a portion facing the coil conductor 16 in the first direction D1. The insulating portion 20 may be formed in the entire second connection conductor 19, or may be formed only in a portion facing the coil conductor 16 in the first direction D1.

As illustrated in FIG. 4, a thickness T1 of the insulating portion 20 is larger (thicker) than a thickness T2 of the oxide film M of the metal magnetic particles P (P1 and P2) (T1>T2). In other words, the thickness T2 of the oxide film M of the metal magnetic particles P (P1 and P2) is smaller (thinner) than the thickness T1 of the insulating portion 20 (T2<T1). The thickness T1 of the insulating portion 20 is 0.1 μm or more and 20.0 μm or less.

As described above, in the multilayer coil component 1 according to the present embodiment, the insulating portions 20 having insulating properties are disposed on the surfaces of the coil conductors 11, 12, 13, 14, 15, 16, and 17 and the second connection conductor 19. The thickness T1 of the insulating portion 20 is larger than the thickness T2 of the oxide film M. As described above, in the multilayer coil component 1, since the insulating portion 20 thicker than the oxide film M is disposed between the coil conductors, occurrence of a short circuit between the coil conductors can be suppressed. Accordingly, in the multilayer electronic component, a withstand voltage between the coil conductors can be improved.

In the multilayer coil component 1 according to the present embodiment, the metal magnetic particles P include the normal particles P1 having the ellipsoid shape and the flat particle P2 having the ellipsoid shape that is flatter in the thickness direction than the normal particles P1. The normal particles P1 and the flat particle P2 may be disposed between the coil conductors 11, 12, 13, 14, 15, 16, and 17 and the second connection conductor 19. Since the flat particle P2 is disposed arranged in a slight gap between the coil conductors, the number of metal magnetic particles P present between the coil conductors can be increased as compared with a case where only the normal particles P1 are used. Accordingly, the number of interfaces of the metal magnetic particles P present between the coil conductors can be sufficiently secured, and the withstand voltage between the coil conductors can be improved. In a case where more flat particles P2 are simply disposed in order to improve the withstand voltage, it is conceivable that a volume ratio of the metal magnetic particles P between the coil conductors increases and a stray capacitance increases. By contrast, in the multilayer coil component 1, the flat particle P2 and the normal particles P1 are mixed between the coil conductors. The normal particles P1 thicker than the flat particle P2 are disposed, and thus, an interval between the metal magnetic particles P can be appropriately secured. Accordingly, an increase in stray capacitance can be suppressed.

In the multilayer coil component 1 according to the present embodiment, the flat particle P2 is disposed such that the surface including the major-axis direction and the minor-axis direction orthogonal to the thickness direction is along the formation surface of the conductor of the magnetic layer 6. In this configuration, the flat particle P2 can increase the number of metal magnetic particles P present between the coil conductors.

In the above first embodiment, a mode in which the insulating portions 20 are disposed on the surfaces on the principal surface 2c side in the coil conductors 11, 12, 13, 14, 15, 16, and 17 and the second connection conductor 19 has been described as an example. However, the insulating portions may be disposed at other positions.

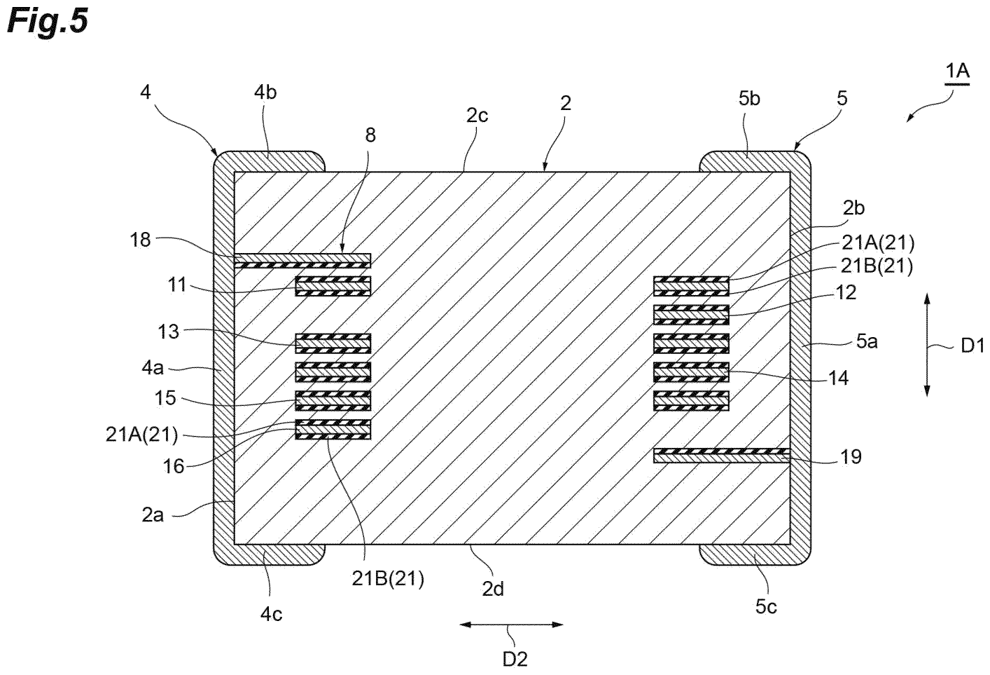

As illustrated in FIG. 5, a multilayer coil component 1A includes an insulating portion 21. The insulating portions 21 include first portions 21A and second portions 21B. The first portion 21A is disposed on the surfaces on the principal surface 2c side in the coil conductors 11, 12, 13, 14, 15, 16, and 17 and the second connection conductor 19. The second portion 21B is disposed on surfaces on the principal surface 2d side in the coil conductors 10, 11, 12, 13, 14, 15, and 16 and the first connection conductor 18. In this configuration, the occurrence of the short circuit between the coil conductors facing each other in the first direction D1 can be further suppressed. Accordingly, in the multilayer coil component 1A, a withstand voltage between the coil conductors can be further improved.

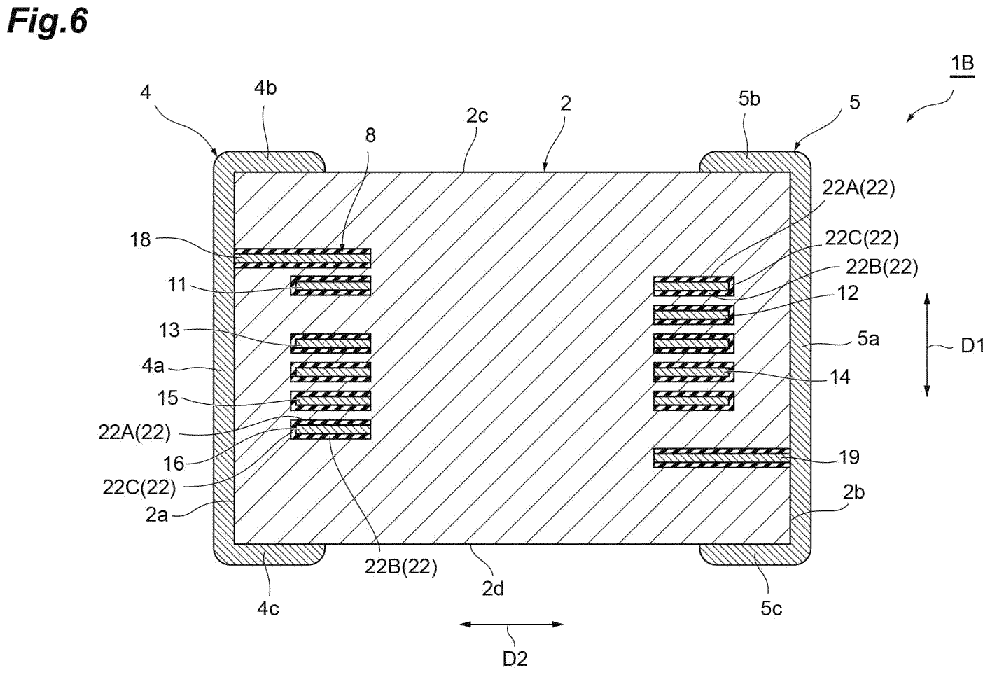

As illustrated in FIG. 6, a multilayer coil component 1B includes insulating portions 22. The insulating portions 22 include first portions 22A, second portions 22B, and third portions 22C. The first portions 22A are disposed on the surfaces on the principal surface 2c side in the coil conductors 11, 12, 13, 14, 15, 16, and 17 and the second connection conductor 19. The second portions 22B are disposed on the surfaces on the principal surface 2d side in the coil conductors 10, 11, 12, 13, 14, 15, and 16 and the first connection conductor 18. The third portions 22C are disposed on side surfaces (surfaces) on the end surfaces 2a and 2b side or the side surfaces 2e and 2f side close to each other in the coil conductors 10, 11, 12, 13, 14, 15, 16, and 17. The third portions 22C may be disposed at positions facing the terminal electrode 4 and the terminal electrode 5 in the coil conductors 11, 12, 13, 14, 15, 16, and 17. In this configuration, the occurrence of the short circuit between the coil conductors facing each other in the first direction D1 and between the coil conductor and the terminal electrodes 4 and 5 can be suppressed. Accordingly, in the multilayer coil component 1B, a withstand voltage between the conductors can be further improved.

In addition, thicknesses of the first portion 22A and the second portion 22B are larger than a thickness of the third portion 22C. In other words, the thickness of the third portion 22C is smaller than the thicknesses of the first portion 22A and the second portion 22B. A distance between the coil conductors is shorter than a distance between the coil conductors and the terminal electrodes 4 and 5. Thus, the short circuit is more likely to occur between the coil conductors than between the coil conductors and the terminal electrodes 4 and 5. Therefore, in the multilayer coil component 1B, the thicknesses of the first portion 22A and the second portion 22B are set to be larger than the thickness of the third portion 22C, and thus, the occurrence of the short circuit between the coil conductors can be suppressed.

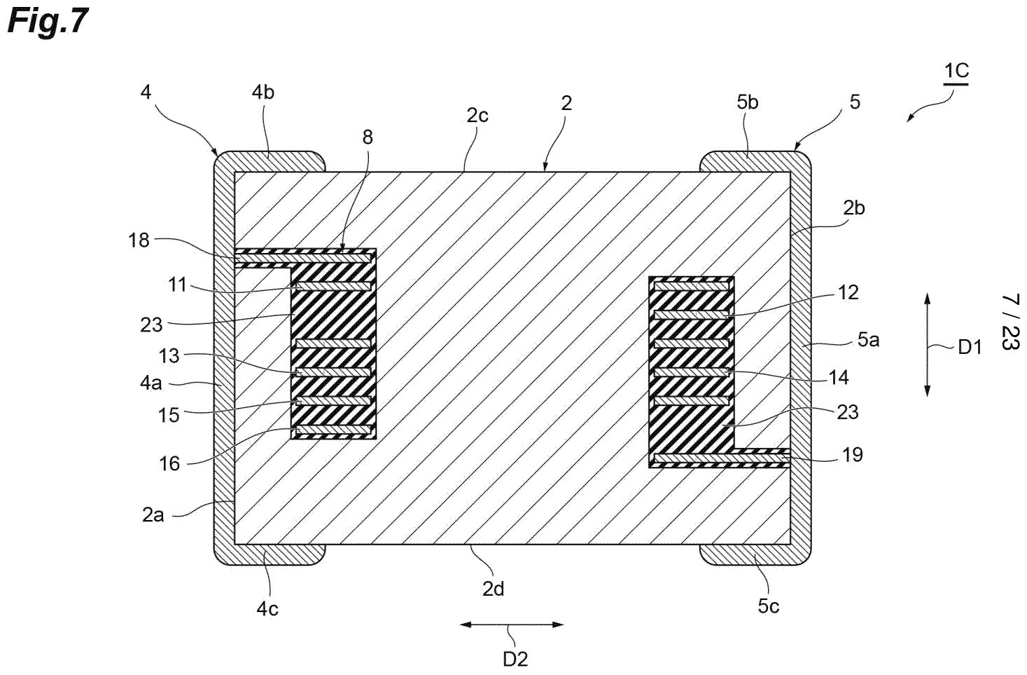

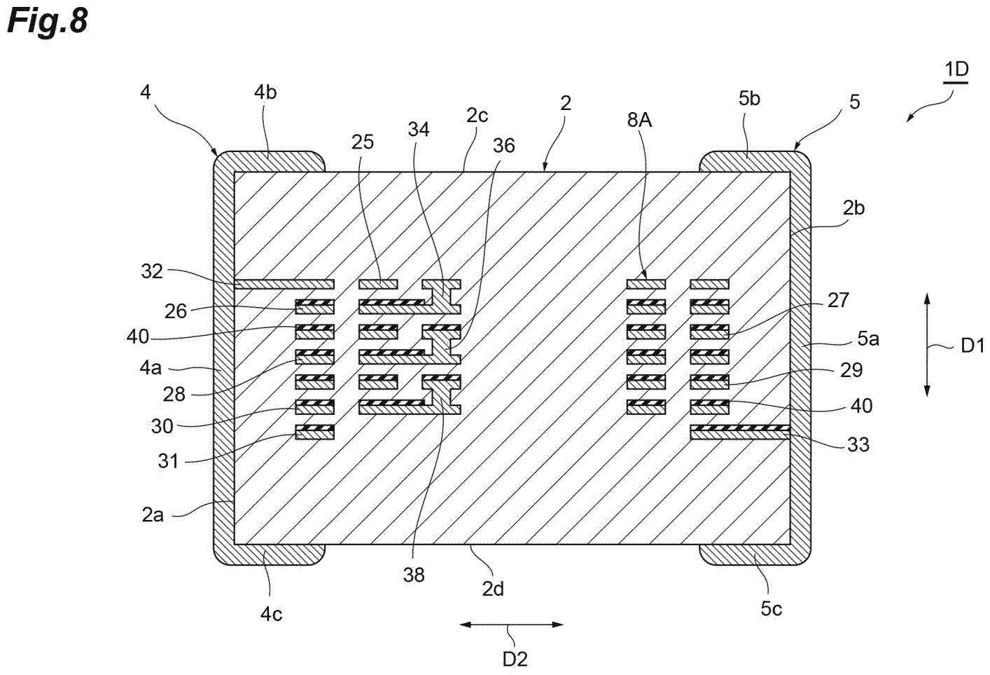

As illustrated in FIG. 7, a multilayer coil component 1C includes insulating portions 23. The insulating portions 23 cover all surfaces of the coil conductors 11, 12, 13, 14, 15, 16, and 17, the first connection conductor 18, and the second connection conductor 19. The insulating portion 23 is disposed across two conductors facing each other in the first direction D1. It can also be said that the insulating portion 23 is filled between the coil conductors facing each other in the first direction D1. In this case, the magnetic layer 6 is not disposed between the coil conductors facing each other in the first direction D1. That is, the metal magnetic particles P are not disposed (not present) between the coil conductors facing each other in the first direction D1. In this configuration, the occurrence of the short circuit between the coil conductors facing each other in the first direction D1 and between the coil conductor and the terminal electrodes 4 and 5 can be suppressed. Accordingly, in the multilayer coil component 1C, a withstand voltage between the conductors can be further improved.

[Second Embodiment] Next, a second embodiment will be described. As illustrated in FIG. 8, in a multilayer coil component 1D according to the second embodiment, a coil 8A is disposed in the element body 2.

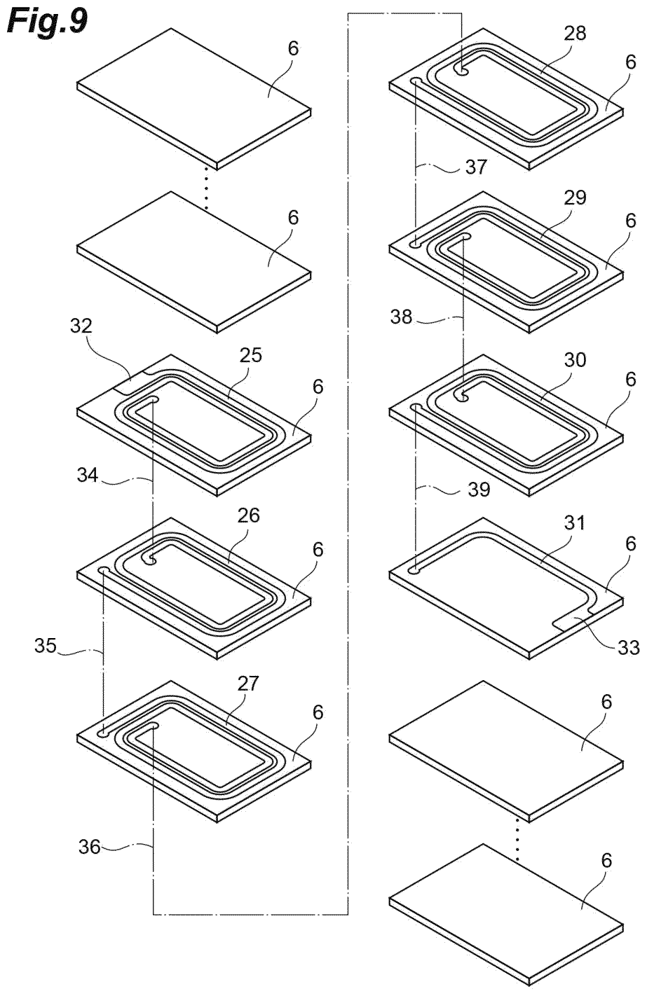

As illustrated in FIG. 9, the coil 8A is formed in a spiral shape by electrically connecting a plurality of coil conductors 25, 26, 27, 28, 29, 30, and 31 to a first connection conductor 32 and a second connection conductor 33. The coil conductor 25 and the first connection conductor 32 are integrally formed. The coil conductor 31 and the second connection conductor 33 are integrally formed. Adjacent coil conductors 25, 26, 27, 28, 29, 30, and 31 are electrically connected by through-hole conductors 34, 35, 36, 37, 38, and 39. The first connection conductor 32 constitutes one end portion of the coil 8A. The first connection conductor 32 is exposed on the end surface 2a of the element body 2 and is connected to the terminal electrode 4 (first electrode portion 4a). The second connection conductor 33 constitutes the other end portion of the coil 8A. The second connection conductor 33 is exposed on the end surface 2b of the element body 2 and is connected to the terminal electrode 5 (first electrode portion 5a).

The coil conductors 25, 26, 27, 28, 29, and 30 have a spiral shape as viewed from the first direction D1 (direction along a coil axis). Each of the coil conductors 25, 26, 27, 28, 29, and 30 has a first conductor portion extending linearly and a second conductor portion connecting the first conductor portion. Each of the coil conductors 25, 26, 27, 28, 29, and 30 has portions (outer portion and inner portion) adjacent to each other in the in-plane direction of the magnetic layer 6 (the second direction D2 and the third direction D3). In each of the coil conductors 25, 26, 27, 28, 29, and 30, the first conductor portion and the second conductor portion are disposed at the same height position in the first direction D1.

The coil conductors 25, 26, 27, 28, 29, 30, and 31, the first connection conductor 32, and the second connection conductor 33 are made of a conductive material usually used as a conductor of a coil. For example, Ag, Cu, Au, Al, Pd, a Pd/Ag alloy, or the like can be used as the conductive material. In the present embodiment, the conductive material is Ag. The coil conductors 25, 26, 27, 28, 29, 30, and 31, the first connection conductor 32, and the second connection conductor 33 are formed as a sintered body of a conductive paste containing the conductive material.

As illustrated in FIG. 8, in the multilayer coil component 1D, insulating portions (second insulating portions) 40 are formed on surfaces of the coil conductors 26, 27, 28, 29, 30, and 31 and the second connection conductor 33. The insulating portions 40 are formed by forming Cu plating on the surfaces of the coil conductors 26, 27, 28, 29, 30, and 31 and the second connection conductor 33 by an electroless plating method and blackening the Cu plating.

The insulating portions 40 are disposed on the surfaces (upper surfaces) of the coil conductors 26, 27, 28, 29, 30, and 31 and the second connection conductor 33 on the principal surface 2c side. The insulating portion 40 is disposed between the coil conductor 26 and the coil conductor 25 and the first connection conductor 32. The insulating portion 40 is disposed between the coil conductor 27 and the coil conductor 26. The insulating portion 40 is disposed between the coil conductor 28 and the coil conductor 27. The insulating portion 40 is disposed between the coil conductor 29 and the coil conductor 28. The insulating portion 40 is disposed between the coil conductor 30 and the coil conductor 29. The insulating portion 40 is disposed between the coil conductor 31 and the coil conductor 30.

The insulating portions 40 are not formed in portions where the through-hole conductors 34, 35, 36, 37, 38, and 39 are formed in the coil conductors 26, 27, 28, 29, 30, and 31. The insulating portion 40 may be formed in the entire coil conductor 26, or may be formed only in a portion facing the coil conductor 25 and the first connection conductor 32 in the first direction D1. The insulating portion 40 may be formed in the entire coil conductor 27, or may be formed only in a portion facing the coil conductor 26 in the first direction D1. The insulating portion 40 may be formed in the entire coil conductor 28, or may be formed only in a portion facing the coil conductor 27 in the first direction D1. The insulating portion 40 may be formed in the entire coil conductor 29, or may be formed only in a portion facing the coil conductor 28 in the first direction D1.

The insulating portion 40 may be formed in the entire coil conductor 30, or may be formed only in a portion facing the coil conductor 29 in the first direction D1. The insulating portion 40 may be formed in the entire coil conductor 31, or may be formed only in a portion facing the coil conductor 30 in the first direction D1. The insulating portion 40 may be formed in the entire second connection conductor 33, or may be formed only in a portion facing the coil conductor 30 in the first direction D1.

A thickness of the insulating portion 40 is larger (thicker) than the thickness T2 of the oxide film M of the metal magnetic particles P (P1 and P2). In other words, the thickness T2 of the oxide film M of the metal magnetic particles P (P1 and P2) is smaller (thinner) than the thickness T1 of the insulating portion 40.

As described above, in the multilayer coil component 1D according to the present embodiment, the insulating portions 40 having insulating properties are disposed on the surfaces of the coil conductors 26, 27, 28, 29, 30, and 31 and the second connection conductor 33. The thickness of the insulating portion 40 is larger than the thickness of the oxide film M. As described above, in the multilayer coil component 1D, since the insulating portion 40 thicker than the oxide film M is disposed between the coil conductors, the occurrence of the short circuit between the coil conductors can be suppressed. Accordingly, in the multilayer coil component 1D, a withstand voltage between the coil conductors can be improved.

In the second embodiment, a mode in which the insulating portions 40 are disposed on the surfaces on the principal surface 2c side in the coil conductors 26, 27, 28, 29, 30, and 31 and the second connection conductor 33 has been described as an example. However, the insulating portions may be disposed at other positions.

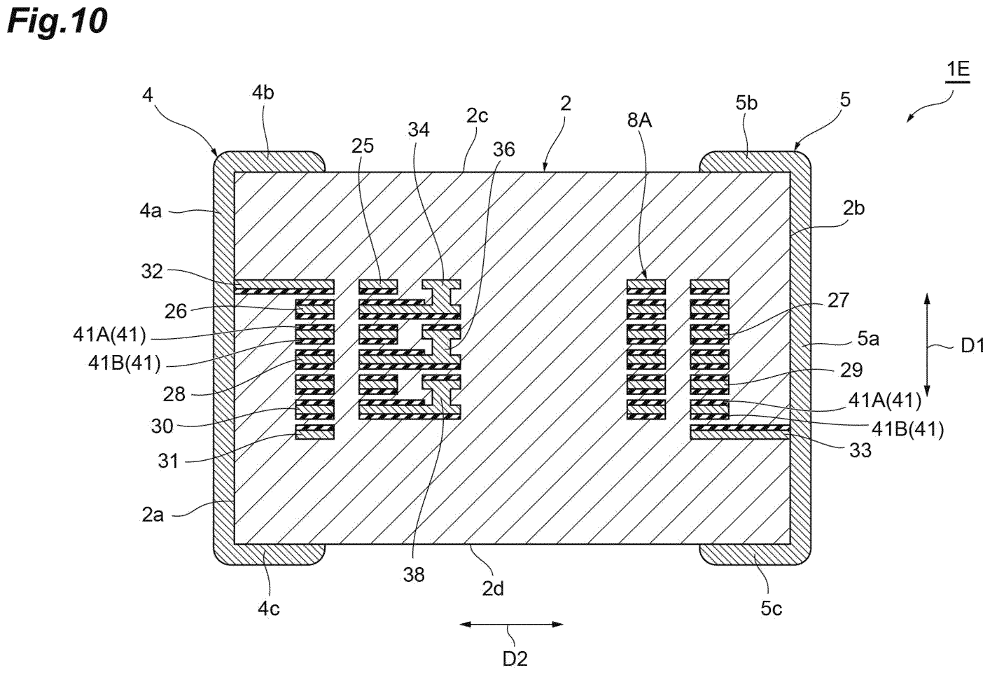

As illustrated in FIG. 10, a multilayer coil component 1E includes insulating portions 41. The insulating portions 41 include first portions 41A and second portions 41B. The first portions 41A are disposed on surfaces on the principal surface 2c side in the coil conductors 26, 27, 28, 29, 30, and 31 and the second connection conductor 33. The second portions 41B are disposed on surfaces on the principal surface 2d side in the coil conductors 25, 26, 27, 28, 29, 30, and 31 and the first connection conductor 32. In this configuration, the occurrence of the short circuit between the coil conductors facing each other in the first direction D1 can be further suppressed. Accordingly, in the multilayer coil component 1E, a withstand voltage between the coil conductors can be further improved.

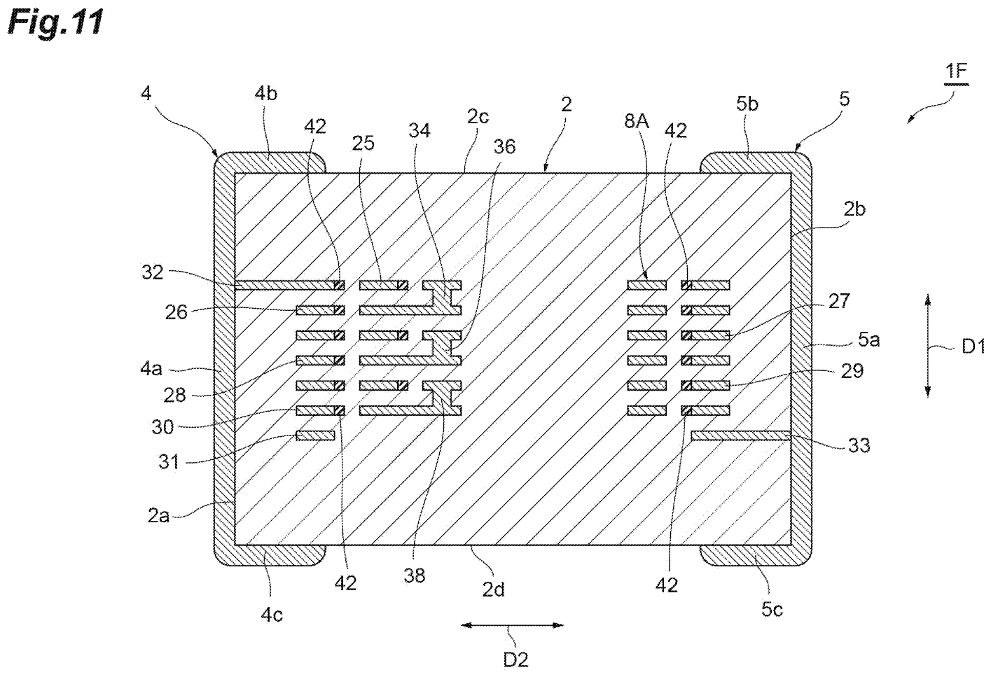

As illustrated in FIG. 11, a multilayer coil component 1F includes insulating portions 42. The insulating portions 42 are disposed on one side surface of a pair of portions facing each other in the in-plane direction of the magnetic layer 6 in the coil conductors 25, 26, 27, 28, 29, and 30 and the first connection conductor 32. In this configuration, the occurrence of the short circuit between the coil conductors facing each other in the in-plane direction of the magnetic layer 6 can be suppressed. Accordingly, in the multilayer coil component 1F, a withstand voltage between the coil conductors can be improved.

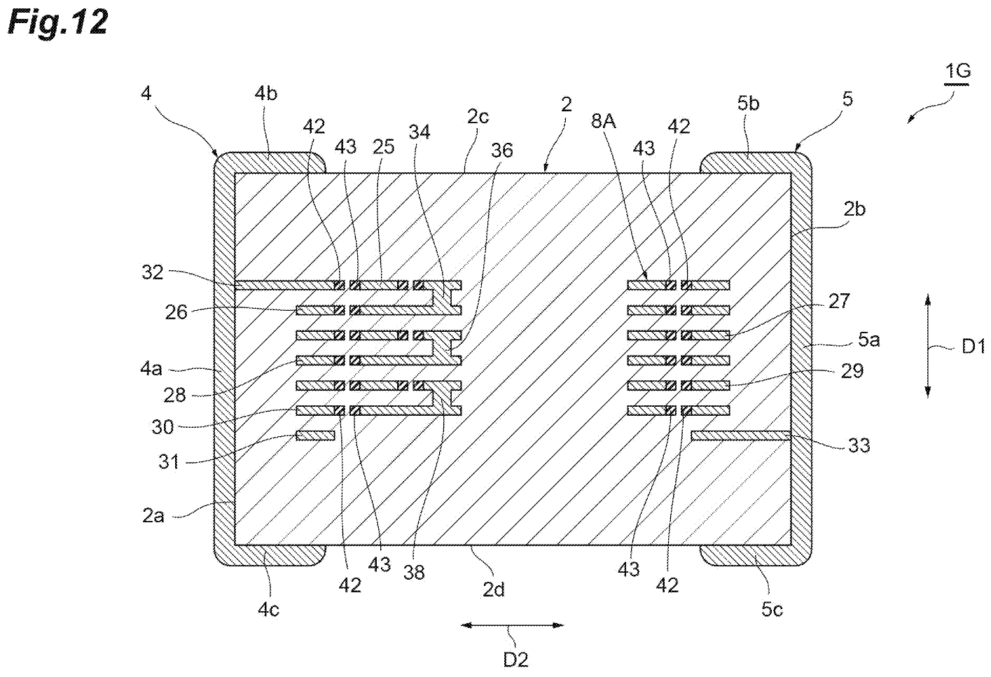

As illustrated in FIG. 12, a multilayer coil component 1G includes insulating portions 42 and insulating portions 43. The insulating portions 42 and the insulating portions 43 are disposed on side surfaces of a pair of portions facing each other in the in-plane direction of the magnetic layer 6 in the coil conductors 25, 26, 27, 28, 29, and 30 and the first connection conductor 32. In this configuration, the occurrence of the short circuit between the coil conductors facing each other in the in-plane direction of the magnetic layer 6 can be suppressed. Accordingly, in the multilayer coil component 1G, a withstand voltage between the coil conductors can be improved.

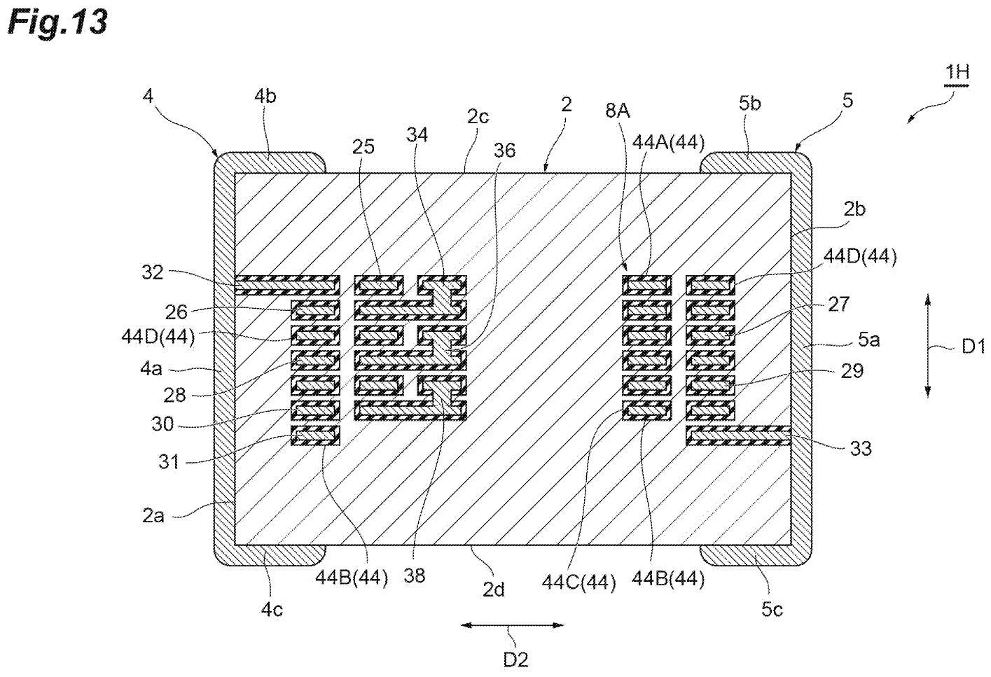

As illustrated in FIG. 13, a multilayer coil component 1H includes insulating portions 44. The insulating portions 44 cover all surfaces of the coil conductors 25, 26, 27, 28, 29, 30, and 31, the first connection conductor 32, and the second connection conductor 33. The insulating portions 44 include first portions (inter-conductor portions) 44A, second portions (inter-conductor portions) 44B, third portions (inter-conductor-portion portions) 44C, and fourth portions (inter-conductor-portion portions) 44D.

The first portions 44A are disposed on the surfaces on the principal surface 2c side in the coil conductors 25, 26, 27, 28, 29, 30, and 31, the first connection conductor 32, and the second connection conductor 33. The second portions 44B are disposed on the surfaces on the principal surface 2d side in the coil conductors 25, 26, 27, 28, 29, 30, and 31, the first connection conductor 32, and the second connection conductor 33. The third portions 44C and the fourth portions 44D are disposed on the side surfaces of the coil conductors 25, 26, 27, 28, 29, and 30, the first connection conductor 32, and the second connection conductor 33. In this configuration, the occurrence of the short circuit between the coil conductors facing each other in the first direction D1 and between the coil conductor and the terminal electrodes 4 and 5 can be suppressed. Accordingly, in the multilayer coil component 1H, a withstand voltage between the conductors can be further improved.

In addition, thicknesses of the first portion 44A and the second portion 44B are larger (thicker) than thicknesses of the third portion 44C and the fourth portion 44D. In other words, the thicknesses of the third portion 44C and the fourth portion 44D are smaller (thinner) than the thicknesses of the first portion 44A and the second portion 44B. The short circuit is more likely to occur between the coil conductors facing each other in the first direction D1 than between the coil conductors (conductor portions) facing each other in the in-plane direction. Therefore, in the multilayer coil component 1H, the thicknesses of the first portion 44A and the second portion 44B are set to be larger than the thicknesses of the third portion 44C and the fourth portion 44D, and thus, the occurrence of the short circuit between the coil conductors can be suppressed.

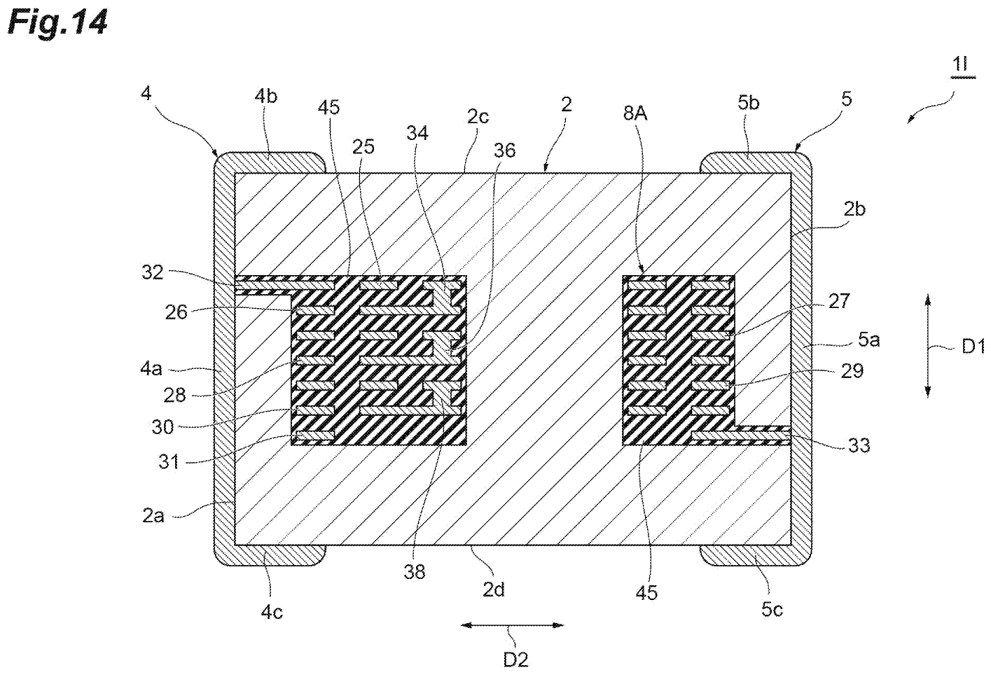

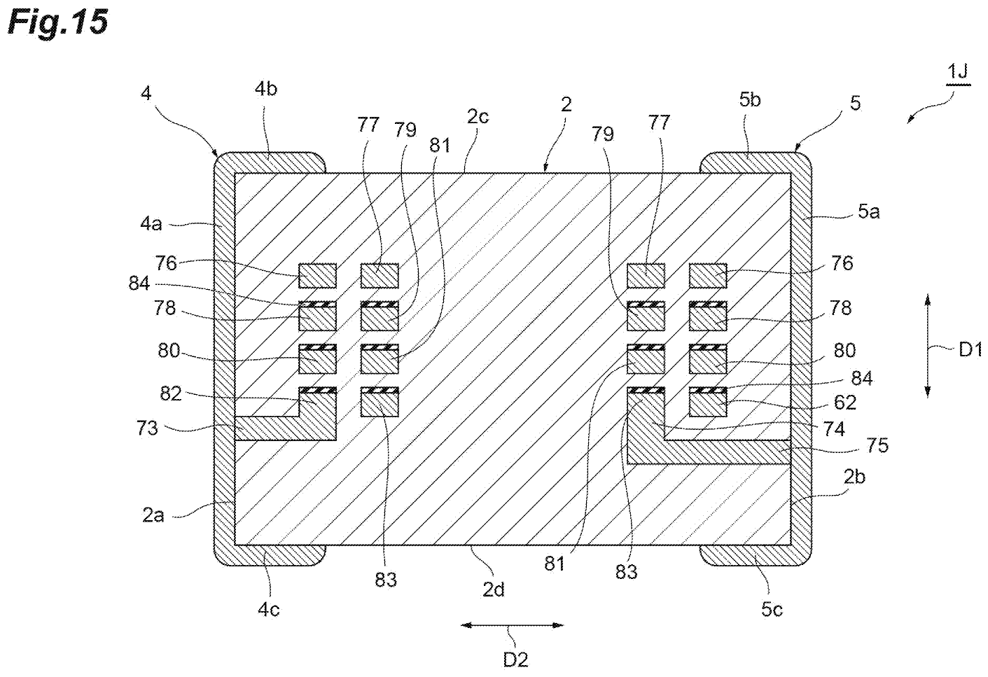

As illustrated in FIG. 14, a multilayer coil component 11 includes insulating portions 45. The insulating portions 45 cover all surfaces of the coil conductors 25, 26, 27, 28, 29, 30, and 31, the first connection conductor 32, and the second connection conductor 33. The insulating portion 45 is disposed across two conductors facing each other in the first direction D1. It can also be said that the insulating portion 45 is filled between the coil conductors facing each other in the first direction D1. In this case, the magnetic layer 6 is not disposed between the coil conductors facing each other in the first direction D1. That is, the metal magnetic particles P are not disposed (not present) between the coil conductors facing each other in the first direction D1. In this configuration, the occurrence of the short circuit between the coil conductors facing each other in the first direction D1 and between the coil conductor and the terminal electrodes 4 and 5 can be suppressed. Accordingly, in the multilayer coil component 1I, a withstand voltage between the conductors can be further improved.

[Third Embodiment] Next, a third embodiment will be described. As illustrated in FIG. 15, in a multilayer coil component 1J according to the third embodiment, a coil 8B is disposed in the element body 2.

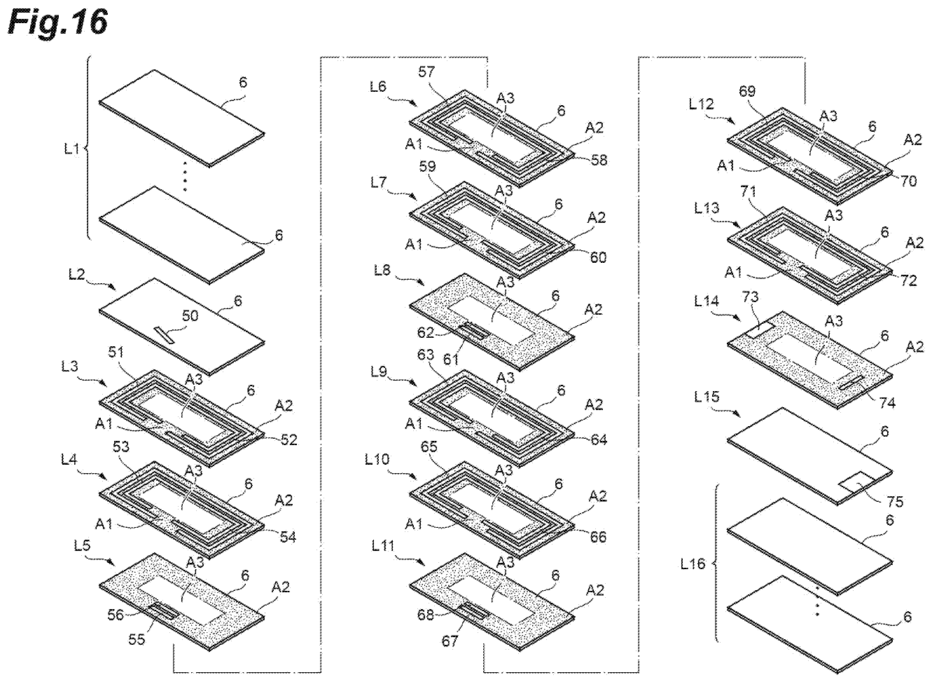

As illustrated in FIG. 16, a plurality of layers constituting the coil 8B includes cover layers L1, a first conductor pattern layer L2, a second conductor pattern layer L3, a third conductor pattern layer L4, a fourth conductor pattern layer L5, a fifth conductor pattern layer L6, a sixth conductor pattern layer L7, a seventh conductor pattern layer L8, an eighth conductor pattern layer L9, a ninth conductor pattern layer L10, a tenth conductor pattern layer L11, an eleventh conductor pattern layer L12, a twelfth conductor pattern layer L13, a thirteenth conductor pattern layer L14, a fourteenth conductor pattern layer L15, and cover layers L16. The cover layers L1 and L16 are layers including only of the magnetic layers 6 containing the metal magnetic particles P. A plurality of cover layers L1 is disposed on the principal surface 2c side of the element body 2. A plurality of the cover layers L16 is disposed on the principal surface 2d side of the element body 2. Each layer excluding the cover layers L1 and L16 is formed by hollowing out the magnetic layer 6 containing the above-described metal magnetic particles P in a shape corresponding to the conductor and disposing the conductor in the hollowed portion. Thus, in each of these layers, the magnetic layer 6 and the conductor are flush with each other.

The conductor is made of a conductive material usually used as a conductor of a coil. For example, Ag, Cu, Au, Al, Pd, a Pd/Ag alloy, or the like can be used as the conductive material. In the present embodiment, the conductive material is Ag. For example, laser processing can be used to hollow out the magnetic layer 6. For example, a printing method or a thin film growth method can be used for forming the conductor portion.

The first conductor pattern layer L2 is stacked between the cover layer L1 and the second conductor pattern layer L3. The first conductor pattern layer L2 includes a connection line 50. The connection line 50 connects an end portion of an outer conductor line 51 (to be described later) of the second conductor pattern layer L3 and an inner conductor line 52 (to be described later). The connection line 50 extends obliquely at a position corresponding to a divided region A1 (to be described later).

The second conductor pattern layer L3 is stacked between the first conductor pattern layer L2 and the third conductor pattern layer L4. The second conductor pattern layer L3 includes the outer conductor line 51 and the inner conductor line 52. The outer conductor line 51 is disposed in a rectangular annular shape having a shape slightly smaller than an outer shape of the second conductor pattern layer L3, and the inner conductor line 52 is disposed in a rectangular annular shape having a shape slightly further smaller than the outer conductor line 51. A width of the outer conductor line 51 and a width of the inner conductor line 52 are substantially the same. The outer conductor line 51 and the inner conductor line 52 are separated from each other at an interval smaller than the widths of these lines.

The outer conductor line 51 and the inner conductor line 52 are partially divided in a predetermined divided region A1. The divided region A1 is, for example, ¼ or less of a length of one turn of each of the outer conductor line 51 and the inner conductor line 52. An interval between two end portions of the outer conductor line 51 is equal to an interval between two end portions of the inner conductor line 52.

The third conductor pattern layer L4 is stacked between the second conductor pattern layer L3 and the fourth conductor pattern layer L5. The third conductor pattern layer L4 includes an outer conductor line 53 and an inner conductor line 54. The outer conductor line 53 is disposed in a rectangular annular shape having a shape slightly smaller than an outer shape of the third conductor pattern layer L4, and the inner conductor line 54 is disposed in a rectangular annular shape having a shape slightly further smaller than the outer conductor line 53. A width of the outer conductor line 53 and a width of the inner conductor line 54 are substantially the same. The outer conductor line 53 and the inner conductor line 54 are separated from each other at an interval smaller than the widths of these lines.

The outer conductor line 53 and the inner conductor line 54 are partially divided in a predetermined divided region A1. The divided region A1 is, for example, ¼ or less of a length of one turn of each of the outer conductor line 53 and the inner conductor line 54. An interval between two end portions of the outer conductor line 53 is equal to an interval between two end portions of the inner conductor line 54.

The fourth conductor pattern layer L5 is stacked between the third conductor pattern layer L4 and the fifth conductor pattern layer L6. The fourth conductor pattern layer L5 is a layer that stepwisely connects outer conductor lines 53 and 57 and inner conductor lines 54 and 58 of the third conductor pattern layer L4 and the fifth conductor pattern layer L6 adjacent to each other in a stacking direction. The fourth conductor pattern layer L5 includes an outer connection line 55 and an inner connection line 56. Both the outer connection line 55 and the inner connection line 56 have a linear shape and are disposed to correspond to a divided region A1.

The fifth conductor pattern layer L6 is stacked between the fourth conductor pattern layer L5 and the sixth conductor pattern layer L7. The fifth conductor pattern layer L6 includes an outer conductor line 57 and an inner conductor line 58. The outer conductor line 57 is disposed in a rectangular annular shape having a shape slightly smaller than an outer shape of the fifth conductor pattern layer L6, and the inner conductor line 58 is disposed in a rectangular annular shape having a shape slightly further smaller than the outer conductor line 57. A width of the outer conductor line 57 and a width of the inner conductor line 58 are substantially the same. The outer conductor line 57 and the inner conductor line 58 are separated from each other at an interval smaller than the widths of these lines.

The outer conductor line 57 and the inner conductor line 58 are partially divided in a predetermined divided region A1. The divided region A1 is, for example, ¼ or less of a length of one turn of each of the outer conductor line 57 and the inner conductor line 58. An interval between two end portions of the outer conductor line 57 is equal to an interval between two end portions of the inner conductor line 58.

The sixth conductor pattern layer L7 is stacked between the fifth conductor pattern layer L6 and the seventh conductor pattern layer L8. The sixth conductor pattern layer L7 includes an outer conductor line 59 and an inner conductor line 60. The outer conductor line 59 is disposed in a rectangular annular shape having a shape slightly smaller than an outer shape of the sixth conductor pattern layer L7, and the inner conductor line 60 is disposed in a rectangular annular shape having a shape slightly further smaller than the outer conductor line 59. A width of the outer conductor line 59 and a width of the inner conductor line 60 are substantially the same. The outer conductor line 59 and the inner conductor line 60 are separated from each other at an interval smaller than the widths of these lines.

The outer conductor line 59 and the inner conductor line 60 are partially divided in a predetermined divided region A1. The divided region A1 is, for example, ¼ or less of a length of one turn of each of the outer conductor line 59 and the inner conductor line 60. An interval between two end portions of the outer conductor line 59 is equal to an interval between two end portions of the inner conductor line 60.

The seventh conductor pattern layer L8 is stacked between the sixth conductor pattern layer L7 and the eighth conductor pattern layer L9. The seventh conductor pattern layer L8 is a layer that stepwisely connects outer conductor lines 59 and 63 and inner conductor lines 60 and 64 of the sixth conductor pattern layer L7 and the eighth conductor pattern layer L9 adjacent to each other in a stacking direction. The seventh conductor pattern layer L8 includes an outer connection line 61 and an inner connection line 62. Both the outer connection line 61 and the inner connection line 62 have a linear shape and are disposed so correspond to a divided region A1.

The eighth conductor pattern layer L9 is stacked between the seventh conductor pattern layer L8 and the ninth conductor pattern layer L10. The eighth conductor pattern layer L9 includes an outer conductor line 63 and an inner conductor line 64. The outer conductor line 63 is disposed in a rectangular annular shape having a shape slightly smaller than an outer shape of the eighth conductor pattern layer L9, and the inner conductor line 64 is disposed in a rectangular annular shape having a shape slightly further smaller than the outer conductor line 63. A width of the outer conductor line 63 and a width of the inner conductor line 64 are substantially the same. The outer conductor line 63 and the inner conductor line 64 are separated from each other at an interval smaller than the widths of these lines.

The outer conductor line 63 and the inner conductor line 64 are partially divided in a predetermined divided region A1. The divided region A1 is, for example, ¼ or less of a length of one turn of each of the outer conductor line 63 and the inner conductor line 64. An interval between two end portions of the outer conductor line 63 is equal to an interval between two end portions of the inner conductor line 64.

The ninth conductor pattern layer L10 is stacked between the eighth conductor pattern layer L9 and the tenth conductor pattern layer L11. The ninth conductor pattern layer L10 includes an outer conductor line 65 and an inner conductor line 66. The outer conductor line 65 is disposed in a rectangular annular shape having a shape slightly smaller than an outer shape of the ninth conductor pattern layer L10, and the inner conductor line 66 is disposed in a rectangular annular shape having a shape further slightly smaller than the outer conductor line 65. A width of the outer conductor line 65 and a width of the inner conductor line 66 are substantially the same. The outer conductor line 65 and the inner conductor line 66 are separated from each other at an interval smaller than the widths of these lines.

The outer conductor line 65 and the inner conductor line 66 are partially divided in a predetermined divided region A1. The divided region A1 is, for example, ¼ or less of a length of one turn of each of the outer conductor line 65 and the inner conductor line 66. An interval between two end portions of the outer conductor line 65 is equal to an interval between two end portions of the inner conductor line 66.

The tenth conductor pattern layer L11 is stacked between the ninth conductor pattern layer L10 and the eleventh conductor pattern layer L12. The tenth conductor pattern layer L11 is a layer that stepwisely connects outer conductor lines 65 and 69 and inner conductor lines 66 and 70 of the ninth conductor pattern layer L10 and the eleventh conductor pattern layer L12 adjacent to each other in a stacking direction. The tenth conductor pattern layer L11 includes an outer connection line 67 and an inner connection line 68. Both the outer connection line 67 and the inner connection line 68 have a linear shape and are disposed so correspond to a divided region A1.

The eleventh conductor pattern layer L12 is stacked between the tenth conductor pattern layer L11 and the twelfth conductor pattern layer L13. The eleventh conductor pattern layer L12 includes an outer conductor line 69 and an inner conductor line 70. The outer conductor line 69 is disposed in a rectangular annular shape having a shape slightly smaller than an outer shape of the eleventh conductor pattern layer L12, and the inner conductor line 70 is disposed in a rectangular annular shape having a shape further slightly smaller than the outer conductor line 69. A width of the outer conductor line 69 and a width of the inner conductor line 70 are substantially the same. The outer conductor line 69 and the inner conductor line 70 are separated from each other at an interval smaller than the widths of these lines.

The outer conductor line 69 and the inner conductor line 70 are partially divided in a predetermined divided region A1. The divided region A1 is, for example, ¼ or less of a length of one turn of each of the outer conductor line 69 and the inner conductor line 70. An interval between two end portions of the outer conductor line 69 is equal to an interval between two end portions of the inner conductor line 70.

The twelfth conductor pattern layer L13 is stacked between the eleventh conductor pattern layer L12 and the thirteenth conductor pattern layer L14. The twelfth conductor pattern layer L13 includes an outer conductor line 71 and an inner conductor line 72. The outer conductor line 71 is disposed in a rectangular annular shape having a shape slightly smaller than an outer shape of the twelfth conductor pattern layer L13, and the inner conductor line 72 is disposed in a rectangular annular shape having a shape slightly further smaller than the outer conductor line 71. A width of the outer conductor line 71 and a width of the inner conductor line 72 are substantially the same. The outer conductor line 71 and the inner conductor line 72 are separated from each other at an interval smaller than the widths of these lines.

The outer conductor line 71 and the inner conductor line 72 are partially divided in a predetermined divided region A1. The divided region A1 is, for example, ¼ or less of a length of one turn of each of the outer conductor line 71 and the inner conductor line 72. An interval between two end portions of the outer conductor line 71 is equal to an interval between two end portions of the inner conductor line 72.

The thirteenth conductor pattern layer L14 includes a lead conductor 73 and a through-hole 74. The lead conductor 73 has a rectangular shape in plan view and is disposed on the end surface 2a side of the element body 2. The lead conductor 73 is connected to the outer conductor line 71 of the twelfth conductor pattern layer L13 and the terminal electrode 4. The through-hole 74 is disposed on the end surface 2b side of the element body 2 to be separated from the lead conductor 73, and is connected to the inner conductor line 72 of the twelfth conductor pattern layer L13.

The fourteenth conductor pattern layer L15 includes a lead conductor 75. The lead conductor 75 has a rectangular shape in plan view and is disposed on the end surface 2b side of the element body 2. The lead conductor 75 connects the inner conductor line 72 of the thirteenth conductor pattern layer L14 to the terminal electrode 5 via the through-hole 74 of the twelfth conductor pattern layer L13.

In the present embodiment, a high resistivity region A2 having a higher resistivity than other regions is provided in a part of the magnetic layer 6 in each of the layers described above. The resistivity mentioned herein refers to an electrical resistivity. The resistivity in the magnetic layer 6 can be adjusted by, for example, adjusting the particle diameter of the metal magnetic particle P contained in the element body 2. For example, an average particle diameter of the metal magnetic particles P is set to be smaller than an average particle diameter of the metal magnetic particles P in other regions, and thus, the high resistivity region A2 can be disposed in a desired region.

In the second conductor pattern layer L3, the third conductor pattern layer L4, the fifth conductor pattern layer L6, the sixth conductor pattern layer L7, the eighth conductor pattern layer L9, the ninth conductor pattern layer L10, the eleventh conductor pattern layer L12, and the twelfth conductor pattern layer L13, a resistivity of a region between the outer conductor lines 51, 53, 57, 59, 63, 65, 69, and 71 and the inner conductor lines 52, 54, 58, 60, 64, 66, 70, and 72 is higher than a resistivity of a central region A3 of the second conductor pattern layer L3, the third conductor pattern layer L4, the fifth conductor pattern layer L6, the sixth conductor pattern layer L7, the eighth conductor pattern layer L9, the ninth conductor pattern layer L10, the eleventh conductor pattern layer L12, and the twelfth conductor pattern layer L13. Here, the central region A3 is a rectangular region positioned inside the inner conductor lines 52, 54, 58, 60, 64, 66, 70, and 72 and slightly smaller than the inner conductor lines 52, 54, 58, 60, 64, 66, 70, and 72.

In the example illustrated in FIG. 16, in any of the second conductor pattern layer L3, the third conductor pattern layer L4, the fifth conductor pattern layer L6, the sixth conductor pattern layer L7, the eighth conductor pattern layer L9, the ninth conductor pattern layer L10, the eleventh conductor pattern layer L12, and the twelfth conductor pattern layer L13, the high resistivity region A2 is disposed so as to surround the outer conductor lines 51, 53, 57, 59, 63, 65, 69, and 71 and the inner conductor lines 52, 54, 58, 60, 64, 66, 70, and 72 except for the central region A3. Accordingly, a region outside the outer conductor lines 51, 53, 57, 59, 63, 65, 69, and 71, a region between the outer conductor lines 51, 53, 57, 59, 63, 65, 69, and 71 and the inner conductor lines 52, 54, 58, 60, 64, 66, 70, and 72, and a region between the inner conductor lines 52, 54, 58, 60, 64, 66, 70, and 72 and the central region A3 become the high resistivity region A2 together with the divided region A1.

In the fourth conductor pattern layer L5, the seventh conductor pattern layer L8, and the tenth conductor pattern layer L11, the high resistivity region A2 is disposed over the entire portion excluding the central region A3. In the fourth conductor pattern layer L5, the seventh conductor pattern layer L8, and the tenth conductor pattern layer L11, peripheries of the outer connection lines 55, 61, and 67 and the inner connection lines 56, 62, and 68 also become the high resistivity region A2. In addition, in the thirteenth conductor pattern layer L14, the high resistivity region A2 is formed except for the central region A3. Accordingly, both the lead conductor 73 and the through-hole 74 are surrounded by the high resistivity region A2.

As illustrated in FIG. 15, the outer conductor line 51 and the outer conductor line 53 constitute a coil conductor 76. The inner conductor line 52 and the inner conductor line 64 constitute a coil conductor 77. The outer conductor line 57 and the outer conductor line 59 constitute a coil conductor 78. The inner conductor line 58 and the inner conductor line 60 constitute a coil conductor 79. The outer conductor line 63 and the outer conductor line 65 constitute a coil conductor 80. The inner conductor line 64 and the inner conductor line 66 constitute a coil conductor 81. The outer conductor line 69 and the outer conductor line 71 constitute a coil conductor 82. The inner conductor line 70 and the inner conductor line 72 constitute a coil conductor 83.

In the multilayer coil component 1J, insulating portions (second insulating portions) 84 are formed on surfaces of the coil conductors 78, 79, 80, 81, 82, and 83. The insulating portions 84 are formed by forming Cu plating on the surfaces of the coil conductors 78, 79, 80, 81, 82, and 83 by an electroless plating method and blackening the Cu plating.

The insulating portions 84 are disposed on surfaces (upper surfaces) of the coil conductors 78, 79, 80, 81, 82, and 83 on the principal surface 2c side. The insulating portion 84 is disposed between the coil conductor 78 and the coil conductor 76. The insulating portion 84 is disposed between the coil conductor 79 and the coil conductor 77. The insulating portion 84 is disposed between the coil conductor 80 and the coil conductor 78. The insulating portion 84 is disposed between the coil conductor 81 and the coil conductor 79. The insulating portion 84 is disposed between the coil conductor 82 and the coil conductor 80. The insulating portion 84 is disposed between the coil conductor 83 and the coil conductor 81.

The insulating portions 84 are not formed at portions connected to the outer connection lines 55, 61, and 67 in the coil conductors 78, 80, and 82. The insulating portions 84 are not formed at portions connected to the inner connection lines 56, 62, and 68 in the coil conductors 79, 81, and 83.

A thickness of the insulating portion 84 is larger (thicker) than the thickness T2 of the oxide film M of the metal magnetic particles P (P1 and P2). In other words, the thickness T2 of the oxide film M of the metal magnetic particles P (P1 and P2) is smaller (thinner) than the thickness T1 of the insulating portion 84.

As described above, in the multilayer coil component 1J according to the present embodiment, the insulating portions 84 having insulating properties are disposed on the surfaces of the coil conductors 78, 79, 80, 81, 82, and 83. The thickness of the insulating portion 84 is larger than the thickness of the oxide film M. As described above, in the multilayer coil component 1J, since the insulating portion 84 thicker than the oxide film M is disposed between the conductors, the occurrence of the short circuit between the coil conductors can be suppressed. Accordingly, in the multilayer coil component 1J, a withstand voltage between the coil conductors can be improved.

In the second embodiment, a mode in which the insulating portions 84 are disposed on the surfaces of the coil conductors 78, 79, 80, 81, 82, and 83 on the principal surface 2c side has been described as an example. However, the insulating portions may be disposed at other positions.

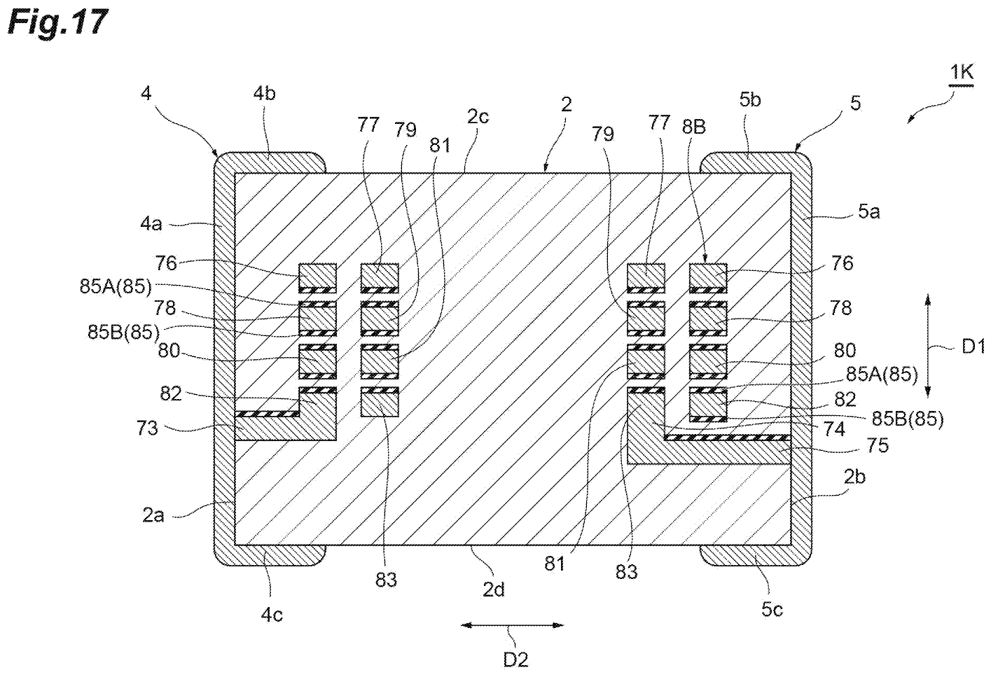

As illustrated in FIG. 17, a multilayer coil component 1K includes insulating portions 85. The insulating portions 85 includes first portions 85A and second portions 85B. The first portions 85A are disposed on surfaces on the principal surface 2c side in the coil conductors 78, 79, 80, 81, 82, and 83 and the lead conductors 73 and 75. The second portions 85B are disposed on surfaces on the principal surface 2d side in the coil conductors 78, 79, 80, 81, 82, and 83. In this configuration, the occurrence of the short circuit between the coil conductors facing each other in the first direction D1 can be further suppressed. Accordingly, in the multilayer coil component 1K, a withstand voltage between the coil conductors can be further improved.

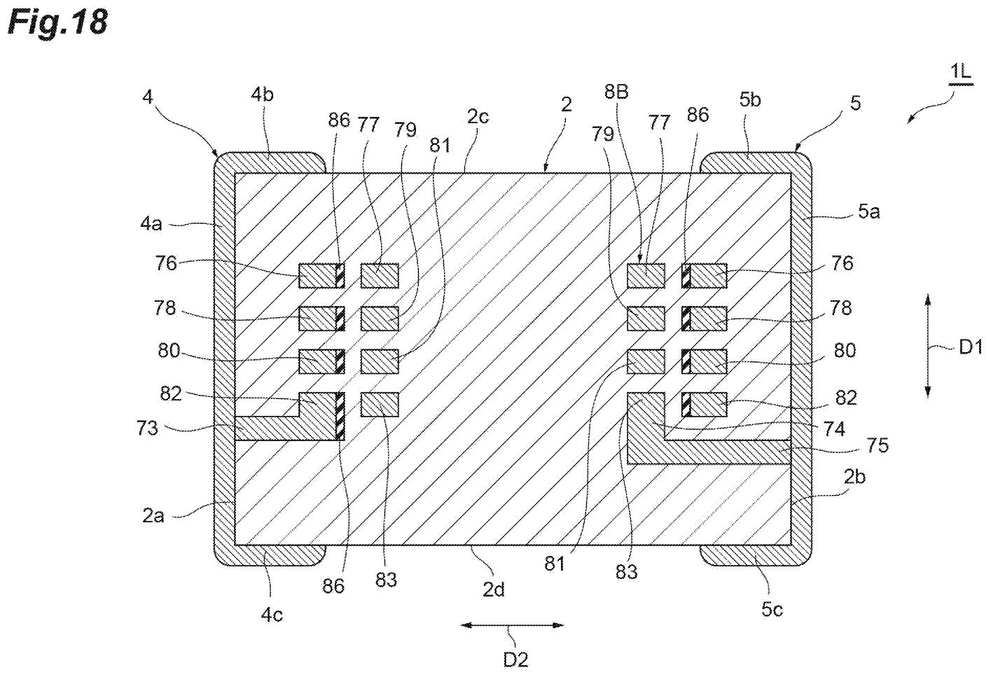

As illustrated in FIG. 18, a multilayer coil component 1L includes insulating portions 86. The insulating portions 86 are disposed on side surfaces facing the coil conductors 77, 79, 81, and 83 in the in-plane direction of the magnetic layer 6 in the coil conductors 76, 78, 80, and 82. The insulating portions 86 are disposed on side surfaces on the end surface 2b side in the lead conductor 73. In this configuration, the occurrence of the short circuit between the coil conductors facing each other in the in-plane direction of the magnetic layer 6 can be suppressed. Accordingly, in the multilayer coil component 1L, a withstand voltage between the coil conductors can be improved.

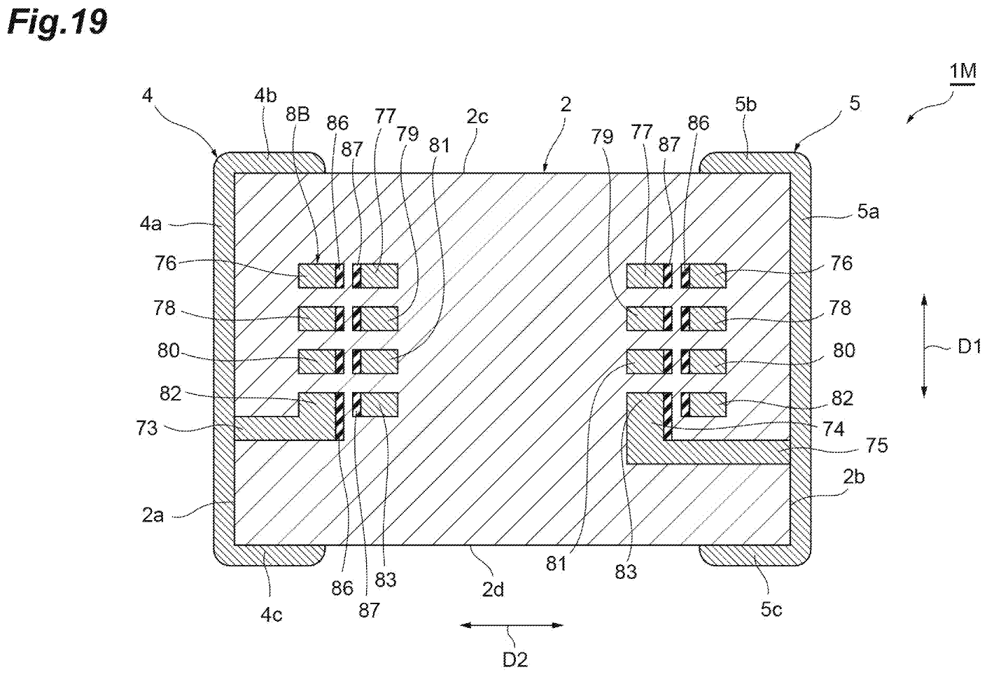

As illustrated in FIG. 19, a multilayer coil component 1M includes insulating portions 86 and insulating portions 87. The insulating portions 86 are disposed on side surfaces facing the coil conductors 77, 79, 81, and 83 in the in-plane direction of the magnetic layer 6 in the coil conductors 76, 78, 80, and 82. The insulating portions 86 are disposed on side surfaces on the end surface 2b side in the lead conductor 73. The insulating portions 87 are disposed on side surfaces facing the coil conductors 76, 78, 80, and 82 in the in-plane direction of the magnetic layer 6 in the coil conductors 77, 79, 81, and 83. In this configuration, the occurrence of the short circuit between the coil conductors facing each other in the in-plane direction of the magnetic layer 6 can be suppressed. Accordingly, in the multilayer coil component 1M, a withstand voltage between the coil conductors can be improved.

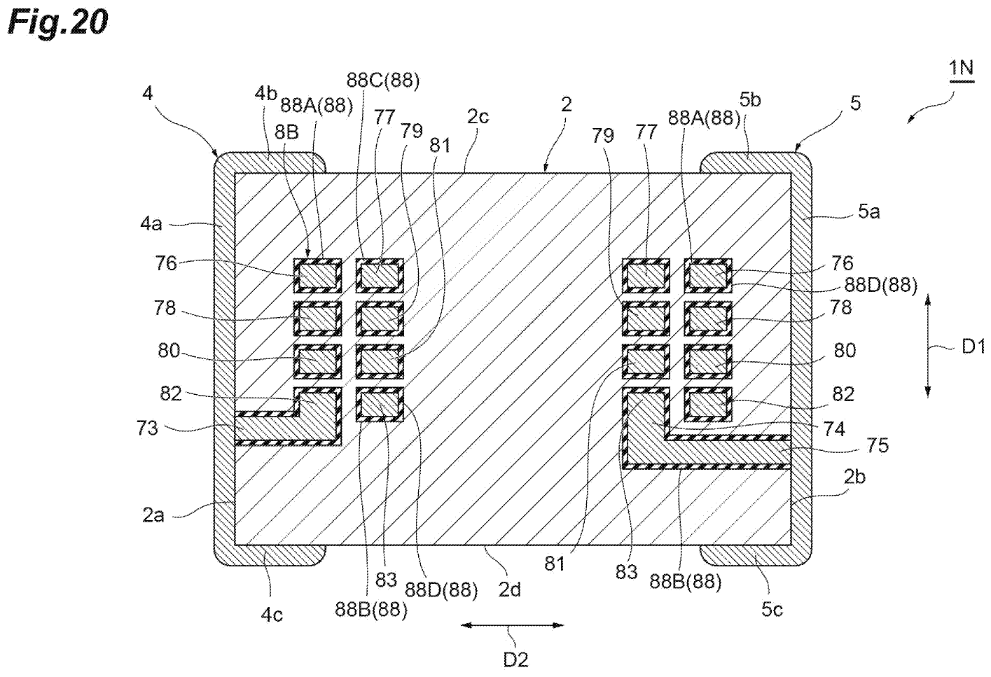

As illustrated in FIG. 20, a multilayer coil component IN includes insulating portions 88. The insulating portions 88 covers all surfaces of the coil conductors 76, 77, 78, 79, 80, 81, 82, and 83 and the lead conductors 73 and 75. The insulating portions 88 includes first portions (inter-conductor portions) 88A, second portions (inter-conductor portions) 88B, third portions (inter-conductor-portion portions) 88C, and fourth portions (inter-conductor-portion portions) 88D.

The first portions 88A are disposed on surfaces on the principal surface 2c side in the coil conductors 76, 77, 78, 79, 80, 81, 82, and 83 and the lead conductors 73 and 75. The second portions 88B are disposed on surfaces on the principal surface 2d side in the coil conductors 76, 77, 78, 79, 80, 81, 82, and 83 and the lead conductors 73 and 75. The third portion 88C and the fourth portion 88D are disposed on the side surfaces of the coil conductors 76, 77, 78, 79, 80, 81, 82, and 83 and the lead conductors 73 and 75. In this configuration, the occurrence of the short circuit between the coil conductors facing each other in the first direction D1 and between the coil conductor and the terminal electrodes 4 and 5 can be suppressed. Accordingly, in the multilayer coil component IN, a withstand voltage between the conductors can be further improved.

In addition, thicknesses of the first portion 88A and the second portion 88B are smaller (thinner) than thicknesses of the third portion 88C and the fourth portion 88D. In other words, the thicknesses of the third portion 88C and the fourth portion 88D are larger (thicker) than the thicknesses of the first portion 88A and the second portion 88B. The short circuit is more likely to occur between the coil conductors facing each other in the in-plane direction than between the coil conductors facing each other in the first direction D1. Therefore, in the multilayer coil component IN, the thicknesses of the third portion 88C and the fourth portion 88D are set to be larger than the thicknesses of the first portion 88A and the second portion 88B, and thus, the occurrence of the short circuit between the coil conductors facing each other in the in-plane direction can be suppressed.

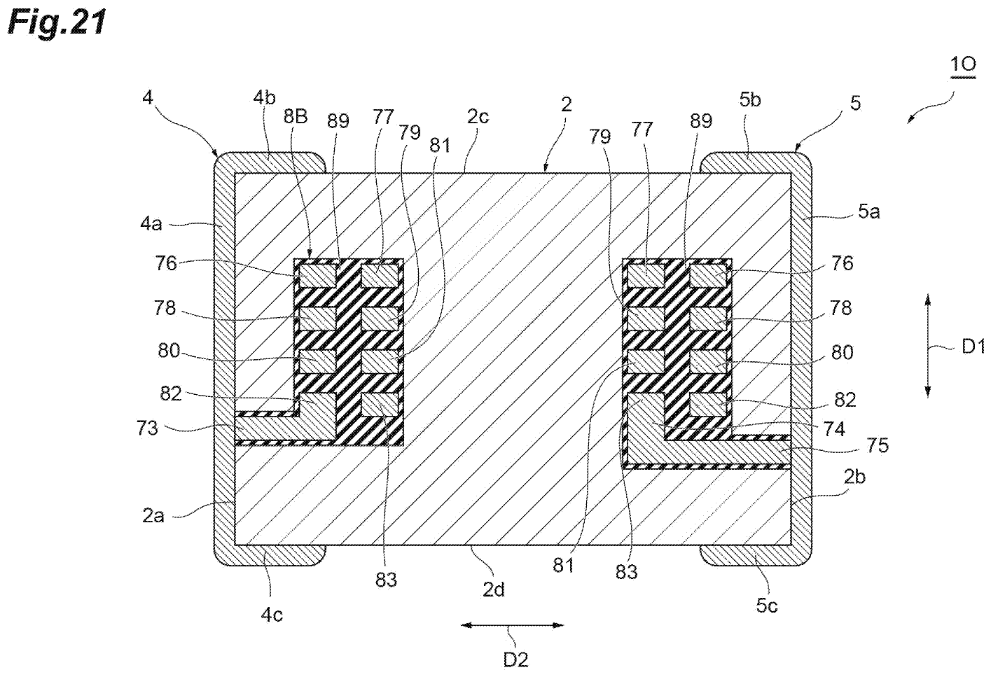

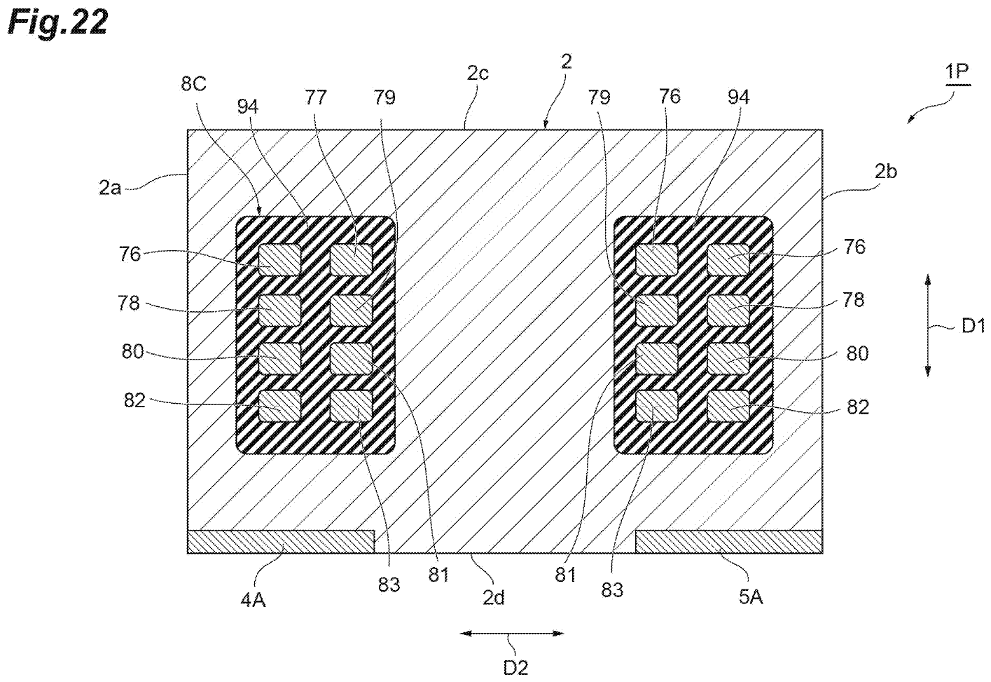

As illustrated in FIG. 21, a multilayer coil component 10 includes insulating portions 89. The insulating portions 89 cover all surfaces of the coil conductors 76, 77, 78, 79, 80, 81, 82, and 83 and the lead conductors 73 and 75. The insulating portion 89 is disposed across two conductors facing each other in the first direction D1. It can also be said that the insulating portion 89 is filled between the coil conductors facing each other in the first direction D1. In this case, the magnetic layer 6 is not disposed between the coil conductors facing each other in the first direction D1. That is, the metal magnetic particles P are not disposed (not present) between the coil conductors facing each other in the first direction D1. In this configuration, the occurrence of the short circuit between the coil conductors facing each other in the first direction D1 and between the coil conductor and the terminal electrodes 4 and 5 can be suppressed. Accordingly, in the multilayer coil component 10, a withstand voltage between the conductors can be further improved.

[Fourth Embodiment] Next, a fourth embodiment will be described. As illustrated in FIG. 22, a multilayer coil component 1P according to the fourth embodiment includes the element body 2, and a terminal electrode 4A and a terminal electrode 5A, which are disposed at a bottom of the element body 2. In the multilayer coil component 1P, a coil 8C is disposed in the element body 2.

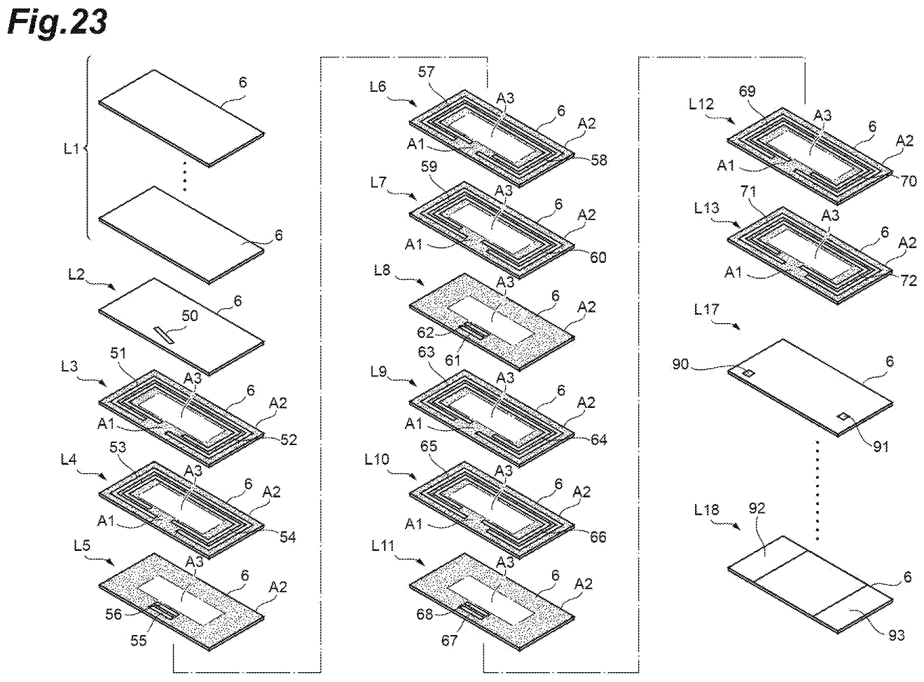

As illustrated in FIG. 23, a plurality of layers constituting the coil 8C includes cover layers L1, a first conductor pattern layer L2, a second conductor pattern layer L3, a third conductor pattern layer L4, a fourth conductor pattern layer L5, a fifth conductor pattern layer L6, a sixth conductor pattern layer L7, a seventh conductor pattern layer L8, an eighth conductor pattern layer L9, a ninth conductor pattern layer L10, a tenth conductor pattern layer L11, an eleventh conductor pattern layer L12, a twelfth conductor pattern layer L13, a thirteenth conductor pattern layer L17, and a fourteenth conductor pattern layer L18.

The thirteenth conductor pattern layer L17 is stacked between the twelfth conductor pattern layer L13 and the fourteenth conductor pattern layer L18. The thirteenth conductor pattern layer L17 is a layer that connects the coil 8C and the terminal electrodes 4A and 5A. The thirteenth conductor pattern layer L17 has a through-hole 90 and a through-hole 91. The through-hole 90 has a rectangular shape in plan view and is disposed on the end surface 2a side of the element body 2. The through-hole 90 is connected to the outer conductor line 71 of the twelfth conductor pattern layer L13. The through-hole 91 has a rectangular shape in plan view, is disposed on the end surface 2b side of the element body 2 to be separated from the through-hole 90, and is connected to the inner conductor line 72 of the twelfth conductor pattern layer L13.

The fourteenth conductor pattern layer L18 includes a terminal conductor 92 and a terminal conductor 93. The terminal conductor 92 and the terminal conductor 93 have a rectangular shape in plan view. The terminal conductor 92 constitutes the terminal electrode 4A. The terminal conductor 92 is connected to the outer conductor line 71 of the twelfth conductor pattern layer L13 via the through-hole 90. The terminal conductor 93 constitutes the terminal electrode 5A. The terminal conductor 93 is connected to the inner conductor line 72 of the twelfth conductor pattern layer L13 via the through-hole 91.

As illustrated in FIG. 22, in the multilayer coil component 1P, insulating portions (second insulating portions) 94 are formed on surfaces of the coil conductors 76, 77, 78, 79, 80, 81, 82, and 83. The insulating portions 94 are formed by forming Cu plating on the surfaces of the coil conductors 76, 77, 78, 79, 80, 81, 82, and 83 by an electroless plating method and blackening the Cu plating.

The insulating portions 94 cover all surfaces of the coil conductors 76, 77, 78, 79, 80, 81, 82, and 83. The insulating portion 94 is disposed across two coil conductors facing each other in the first direction D1. It can also be said that the insulating portion 94 is filled between the coil conductors facing each other in the first direction D1.

As described above, in the multilayer coil component 1P according to the present embodiment, the insulating portions 94 having insulating properties are disposed on the surfaces of the coil conductors 76, 77, 78, 79, 80, 81, 82, and 83. A thickness of the insulating portion 94 is larger than the thickness of the oxide film M. As described above, in the multilayer coil component 1P, since the insulating portion 94 thicker than the oxide film M is disposed between the conductors, the occurrence of the short circuit between the conductors can be suppressed. Accordingly, in the multilayer coil component 1P, a withstand voltage between the conductors can be improved.

Although the embodiments of the present invention have been described above, the present invention is not necessarily limited to the above-described embodiments, and various modifications can be made without departing from the gist thereof.

In the above embodiments, as illustrated in FIG. 4, a mode in which the flat particle P2 comes into contact with the coil conductor 14 has been described as an example. However, the flat particle P2 may not come into contact with the coil conductor 14. For example, the flat particle P2 may be positioned between the normal particles P1 and P1 in the first direction D1. In this case, the normal particles P1 come into contact with the coil conductor.

In the above embodiments, as illustrated in FIG. 4, a mode in which one flat particle P2 is disposed between the coil conductors 14 and 15 has been described as an example. However, a plurality of flat particles P2 may be disposed between the coil conductors.

In the above embodiments, a mode in which the conductive material forming the conductor is Ag has been described as an example. However, the conductor may be a plated conductor. In this configuration, surface roughness of the conductor can be reduced. Thus, in the multilayer coil component, continuity of the insulating portion disposed on the surface of the conductor can be secured. In addition, in a case where heat treatment is performed in a manufacturing process of the multilayer coil component, the plated conductor is less likely to thermally shrink or deform. Thus, occurrence of defects (failures) such as breakage in the insulating portion disposed on the surface of the conductor can be suppressed.

In the above first embodiment and second embodiment, a mode in which the terminal electrode 4 includes the first electrode portion 4a, the second electrode portion 4b, the third electrode portion 4c, the fourth electrode portion 4d, and the fifth electrode portion 4e and the terminal electrode 5 includes the first electrode portion 5a, the second electrode portion 5b, the third electrode portion 5c, the fourth electrode portion 5d, and the fifth electrode portion 5e has been described as an example. However, the shape of the terminal electrode is not limited thereto. For example, the terminal electrode may be disposed only on the principal surface 2d (bottom surface terminal type), or may be disposed over the end surfaces 2a and 2b and the principal surface 2d (L-shaped terminal type).

In the above third embodiment and fourth embodiment, a mode in which the high resistivity region A2 having a higher resistivity than other regions is provided in a part of the magnetic layer 6 in each of the layers described above has been described as an example. However, the high resistivity region A2 may not be provided.

What is claimed is:

1. A multilayer electronic component comprising:
an element body that contains a plurality of metal magnetic particles made of a soft magnetic material; and
at least two conductors that are in contact with the element body, wherein
surfaces of the plurality of metal magnetic particles are covered by a first insulating portion having an insulating property,
a second insulating portion having an insulating property are disposed in at least a part of a surface of at least one conductor of the two conductors in the conductor, and
a thickness of the second insulating portion is larger than a thickness of the first insulating portion.

2. The multilayer electronic component according to claim 1, wherein
the two conductors are coil conductors.

3. The multilayer electronic component according to claim 1, further comprising;
a terminal electrode that is disposed on the element body, wherein
one conductor of the two conductors is a coil conductor, and
the other conductor of the two conductors is the terminal electrode.

4. The multilayer electronic component according to claim 1, wherein
a thickness of the second insulating portion is 0.1 μm or more and 20.0 μm or less.

5. The multilayer electronic component according to claim 1, wherein
the element body is formed by stacking a magnetic layer containing the metal magnetic particles,
the two conductors are disposed to face each other in a stacking direction of the magnetic layer, and
the second insulating portion is disposed between the two conductors.

6. The multilayer electronic component according to claim 5, wherein
the metal magnetic particles include a normal particle having an ellipsoid shape, and a flat particle having an ellipsoid shape flatter in a thickness direction than the normal particle, and
the normal particle and the flat particle are disposed between the two conductors.

7. The multilayer electronic component according to claim 6, wherein
the flat particle is disposed such that a surface including a major-axis direction and a minor-axis direction orthogonal to the thickness direction is along a formation surface of the conductor in the magnetic layer.

8. The multilayer electronic component according to claim 2, wherein
the second insulating portion is disposed across the two conductors.

9. The multilayer electronic component according to claim 1, wherein
the element body is formed by stacking a magnetic layer containing the metal magnetic particles,
the two conductors are coil conductors, and
at least a part of the coil conductor has conductor portions adjacent to each other as viewed from a stacking direction of a plurality of the magnetic layers at the same height position in the stacking direction.

10. The multilayer electronic component according to claim 9, wherein
the two conductors are disposed to face each other in the stacking direction,
the second insulating portion includes an inter-conductor portion disposed between the two conductors facing each other in the stacking direction and an inter-conductor-portion portion disposed between the two conductor portions adjacent to each other, and
a thickness of the inter-conductor portion is larger than a thickness of the inter-conductor-portion portion.

11. The multilayer electronic component according to claim 9, wherein
the two conductors are disposed to face each other in the stacking direction,
the second insulating portion includes an inter-conductor portion disposed between the two conductors facing each other in the stacking direction and an inter-conductor-portion portion disposed between the two conductor portions adjacent to each other, and
a thickness of the inter-conductor portion is smaller than a thickness of the inter-conductor-portion portion.

12. The multilayer electronic component according to claim 1, wherein
the conductor is made of silver.

13. The multilayer electronic component according to claim 1, wherein
the conductor is a plated conductor.
